(19) United States
(12) Patent Application Publication
(10) Pub. No.: US 2007/0021141 A1
(43) Pub. Date: Jan. 25, 2007

(54) Record carrier, system, method and program for conditional access to data stored on the record carrier

(76) Inventors: Kaoru Yokota, Hyogo (JP); Motoji Ohmori, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/573,022

(22) PCT Filed: Oct. 5, 2004
(86) PCT No.: PCT/JP04/14993

§ 371 Date: Mar. 22, 2006

(30) Foreign Application Priority Data
Oct. 16, 2003 (JP) 2003-356072

(51) Int. Cl. H04M 1/00

(52) U.S. Cl. 455/550.1

(57) ABSTRACT

The record carrier of the present invention has a storage area for storing data. The record carrier receives an access requisition to the storage area from a terminal device having the record carrier attached thereto, acquires an access condition indicating authorization to access the storage area, judges whether or not the access requisition satisfies the access condition. When confirming that the access requisition does not satisfy the access condition, the record carrier prevents the access to the storage area. This allows for preventing an unauthorized user from accessing the data stored inside in the case where the record carrier is lost.

### TECHNICAL FIELD

The present invention relates to a record carrier, in particular to a technology for protecting data stored in the record carrier in the case, for example, when the record carrier is lost.

### BACKGROUND ART

Late years, portable information devices having a card slot in which a record carrier, for example an IC card and a memory card, is placed have come into wide use as the multifunctionality of portable information devices, such as cellular phones and PDAs (Personal Digital Assistants), has been advanced.

Recorded onto such record carriers attached to portable information devices are for instance telephone directory data, schedule directory data, and image data taken by digital cameras. The telephone directory data contains personal information including the user's telephone number and mail address, and names of the user's acquaintances, their telephone numbers, mail addresses, and home addresses and so on.

Therefore, a mechanism of proper protection is required so that anyone else other than the user cannot access such data recorded onto the record carrier even if the record carrier or the portable information device having the record carrier attached thereto is lost.

A record carrier disclosed in Patent Document 1 stores personal data as well as a specific invalidation code. When a cellular phone having the record carrier attached thereto is stolen or lost, the user can send the invalidation code to the cellular phone by telephoning to the cellular phone. The cellular phone receives the invalidation code, and then transfers this to the record carrier. The record carrier receives the invalidation code from the cellular phone, and judges whether or not the received invalidation code matches the invalidation code stored in the record carrier in advance. When these two match, then the record carrier locks the personal data and makes it unusable. Herewith, the personal data stored in the card is protected.

[PATENT DOCUMENT 1: Japanese Laid-Open Patent Application No. H11-177682]

### DISCLOSURE OF THE INVENTION

The above technology assumes that the cellular phone having the record carrier attached thereto is in a state capable of receiving the invalidation code transmitted from outside. Therefore, if the record carrier is taken out from the missing cellular phone and attached to another terminal device that can be used offline, the record carrier does not receive the invalidation code and thereby personal data stored therein may be seen by others.

In view of the above problem, the present invention aims at providing a record carrier and a data protection system capable of protecting personal data stored in the record carrier even if the record carrier is attached to another terminal device which can be used offline.

In order to achieve the above object, the present invention is a record carrier comprising: a storage unit; a requisition receiving unit operable to receive, from a terminal device having the record carrier attached thereto, a requisition for access to the storage unit; an acquisition unit operable to acquire an access condition indicating whether or not the terminal device is authorized to access the storage unit; a judging unit operable to judge whether or not the requisition satisfies the access condition; and a prevention unit operable to prevent the access of the terminal device to the storage unit when the judging unit judges that the requisition does not satisfy the access condition.

According to this structure, even if the record carrier receives a requisition for access from the terminal device having the record carrier attached thereto, the record carrier is capable of denying access of the terminal device to the storage area when the access condition is not satisfied.

Here, the record carrier may further comprise an access condition storage unit operable to store the access condition, wherein the acquisition unit acquires the access condition from the access condition storage unit.

According to this structure, since the record carrier stores the access condition therein, the record carrier does not have to acquire from outside the access condition that serves as judgment criteria, even if the terminal device having the record carrier attached thereto is a terminal device that can be used offline. Thus, the record carrier is capable of judging whether or not the requisition for access satisfies the access condition, regardless of the environment in which the terminal device is placed. Consequently, even if the terminal device can be used offline, the record carrier is capable of denying access of the terminal device to the storage area when the access condition is not satisfied.

Here, the access condition may include an identifier list including one or more identifiers which respectively identify one or more devices authorized to access the storage unit. Then, the requisition includes a requiring device identifier for identifying the terminal device. The judging unit judges that, (i) when an identifier matching the requiring device identifier is included in the identifier list, the requisition satisfies the access condition, and (ii) when an identifier matching the requiring device identifier is not included in the identifier list, the requisition does not satisfy the access condition.

According to this structure, the record carrier registers in advance a device ID of the authorized terminal device with the list. This prevents, in the case where the record carrier is lost, the internal data to be read out by attaching the record carrier to another terminal device.

Here, the access condition may include an identifier list including one or more identifiers and one or more sets of number information which correspond one-to-one with the identifiers respectively, the one or more identifiers identifying one or more devices authorized to access the storage unit, each set of number information indicating a count of accesses available for the corresponding device to access the storage unit. Then, the requisition includes a requiring device identifier for identifying the terminal device. The judging unit includes: a holding unit operable to hold a count of accesses indicating how many times the terminal device has accessed the storage unit; a 1st judging subunit operable to judge whether or not an identifier matching the requiring device identifier is included in the identifier list; and a 2nd judging subunit operable to judge, when the 1st judging subunit judges that the matching identifier is included, whether or not a count indicated by a set of number information corresponding to the matching identifier is larger than the count of accesses held by the holding unit. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is prevented that the internal data is read out by attaching the record carrier to another terminal device. In addition, by managing the number of accesses to the storage area, the record carrier can be used as a mechanism for protecting copyrights of data stored in the storage area.

Here, the access condition may include an identifier list including one or more identifiers and one or more sets of period information which correspond one-to-one with the identifiers respectively, the one or more identifiers identifying one or more devices authorized to access the storage unit, each set of period information indicating a time period available for the corresponding device to access the storage unit. Then, the requisition includes a requiring device identifier for identifying the terminal device. The judging unit includes: a time managing unit operable to manage a current data and time; a 1st judging subunit operable to judge whether or not an identifier matching the requiring device identifier is included in the identifier list; and a 2nd judging subunit operable to judge, when the 1st judging subunit judges that the matching identifier is included, whether or not the current time is within a time period indicated by a set of period information corresponding to the matching identifier. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is prevented that the internal data is read out by attaching the record carriers to another terminal device. In addition, by managing the time period allowed to access the storage area, the record carrier can be used as a mechanism for protecting copyrights of data stored in the storage area.

Here, the storage unit may include a plurality of memory blocks. Then, the access condition includes an identifier list including one or more identifiers and one or more sets of memory block information, which correspond one-to-one with the identifiers respectively identifying one or more devices authorized to access the storage unit, the sets of memory block information each indicating one or more of the memory blocks available for each of the corresponding devices to access. The requisition includes a requiring device identifier for identifying the terminal device and memory block specifying information for specifying one of the memory blocks. The judging unit includes: a 1st judging subunit operable to judge whether or not an identifier matching the requiring device identifier is included in the identifier list; and a 2nd judging subunit operable to judge, when the 1st judging subunit judges that the matching identifier is included, whether or not the memory block specified by the memory block specifying information is included in the one or more of the memory blocks indicated by a set of the memory block information corresponding to the matching identifier. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is presented that the internal data is read out by attaching the record carrier to another terminal device. In addition, by managing information on the memory blocks available for access, the record carrier can be used as a mechanism for protecting copyrights of data stored with respect to each memory block.

Here, the storage unit may store one or more sets of program data. Then, the access condition includes an identifier list including one or more identifiers and one or more sets of program information, which correspond one-to-one with the identifiers respectively identifying one or more devices authorized to access the storage unit, the sets of program information each indicating one or more sets of the program data available for each of the corresponding devices to access. The requisition includes a requiring device identifier for identifying the terminal device and program specifying information for specifying one set of the program data. The judging unit includes: a 1st judging subunit operable to judge whether or not an identifier matching the requiring device identifiers included in the identifier list; and a 2nd judging subunit operable to judge, when the 1st judging subunit judges that the matching identifier is included, whether or not the set of program data specified by the program specifying information is included in the one or more sets of the program data indicated by a set of the program information corresponding to the to the matching identifier. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is prevented that the internal data is read out by attaching the record carrier to another terminal device. In addition, by managing the information on the application programs available for access, the record carrier can be used as a mechanism for protecting copyrights of application programs stored in the storage area.

Here, the access condition may include (i) an identifier list including one or more identifiers which respectively identify one or more devices authorized to access the storage unit, and (ii) a biometrics list including one or more sets of biometric information or respectively identifying one or more users authorized to access the storage unit. Then, the requisition includes a requiring device identifier for identifying the terminal device and operator biometric information indicating biometric information of an operator of the terminal device. The judging unit includes: a 1st judging subunit operable to judge whether or not an identifier matching the requiring device identifier is included in the identifier list; and a 2nd judging subunit operable to judge, when the 1st judging subunit judges that the matching identifier is included, whether or not a set of the biometric information corresponding to the operator biometric information is included in the biometrics list. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is prevented that the internal data is read out by attaching the record carrier to another terminal device. In addition, the record carrier registers biometric information of the authorized user with the list in advance. Herewith, even if the record carrier is lost with attached to the authorized terminal device, the implementation of user authentication prevents an unauthorized user from accessing data in the storage area.

Here, the access condition may include (i) an identifier list including one or more identifiers which respectively identify one or more devices authorized to access the storage unit, and (ii) a password list including one or more sets of password information respectively specified by one or more users authorized to access the storage unit. Then, the requisition includes a requiring device identifier for identifying the terminal device and an entry password entered by an operator of the terminal device. The judging unit includes: a 1st judging subunit operable to judge whether or not an identifier matching the requiring device identifier is included in the identifier list; and a 2nd judging subunit operable to judge whether or not a password indicated by a set of password information corresponding to the entry password is included in the password list. The judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

According to this structure, the record carrier registers in advance device IDs of the authorized terminal devices with the list. This way, in the case where the record carrier is lost, it is prevented that the internal data is read out by attaching the record carrier to another terminal device. In addition, the record carrier registers a password specified by the authorized user with the list in advance. Herewith, even if the record carrier is lost with attached to the authorized terminal device, the implementation of password verification prevents an unauthorized user from accessing data in the storage area.

Here, the record carrier may further comprise: an access condition accepting unit operable to accept the access condition from a terminal device having the record carrier attached thereto; and an access condition registration unit operable to register, when the terminal device is authorized, the access condition with the access condition storage unit.

According to this structure, the authorized terminal device registers the access condition indicating that the terminal device itself is authorized to access the storage area while other devices are unauthorized to access the storage area. Herewith, the data in the storage area is protected when the record carrier is attached to different terminal devices.

Furthermore, the authorized terminal device registers not only itself but also other terminal devices used by the same user as access authorized devices. Herewith, the record carrier can be used on those terminal devices of the same user.

In order to accomplish the above object, the record carrier may further comprise: a communication unit operable to communicate with an access condition management server connected via a network, wherein the acquisition unit acquires the access condition from the access condition management server via the communication unit.

Namely, according to this structure, it is not the record carrier itself but the access condition management server that stores the access condition. Herewith, even if the record carrier is lost with attached to the authorized terminal device, the access condition stored by the access condition management server can be rewritten so that the terminal device having the record carrier attached thereto cannot access the storage area.

Here, the acquisition unit may acquire from the access condition management server via the communication unit, along with the access condition, signature data generated based on the access condition. Then, the record carrier may further comprise: a tamper detection unit operable to examine the signature data using a verification key relevant to the access condition management server, and detect whether or not the access condition has been tampered; and a prohibition unit operable to prohibit, when the tamper detection detects that the access condition has been tampered, the judging unit from judging.

According to this structure, the record carrier is capable of judging whether the requisition for access is satisfied or not, using the access condition indeed sent from the access condition management server.

The present invention is also a data protection system comprising a record carrier and a terminal device. The record carrier includes: a storage unit; a requisition receiving unit operable to receive, from a terminal device having the record carrier attached thereto, a requisition for access to the storage unit; an access condition on storage unit operable to store an access condition indicating whether or not the terminal device is authorized to access the storage unit; a judging unit operable to judge whether or not the requisition satisfies the access condition; and a prevention unit operable to prevent the access to the storage unit when the judging unit judges the requisition does not satisfy the access condition. The terminal device includes: a record carrier interface operable to attach the record carrier thereto; an access requisition generation unit operable to generate the requisition of the record carrier to the storage unit; and an access requisition output unit operable to output, to the record carrier, the generated requisition for access.

According to this structure, since the record carrier stores the access condition therein, the record carrier does not have to acquire from outside the access condition that serves as judgment criteria, even if the terminal device having the record carrier attached thereto is a terminal device that can be used offline. Thus, the record carrier is capable of judging whether or not the requisition for access satisfies the access condition, regardless of the environment in which the terminal device is placed. Consequently, even if the terminal device can be used offline, the record carrier is capable of denying access of the terminal device to the storage area when the access condition is not satisfied.

Here, the data protection system may further comprise an access condition registration server operable to register the access condition with the access condition storage unit of the record carrier via the terminal device having the record carrier attached thereto.

According to this structure, if the record carrier is attached to a device capable of being connected with the access condition registration server, the access condition can be registered with the record carrier.

The present invention is also a data protection system comprising: a record carrier; a terminal device; and an access condition management server. The record carrier includes: a storage unit; a requisition receiving unit operable to receive, from a terminal device having the record carrier attached thereto, a requisition for access to the storage unit; an access condition storage unit operable to store an access condition indicating whether or not the terminal device is authorized to access the storage unit; a judging unit operable to judge whether or not the requisition satisfies the access condition; and a prevention unit operable to prevent the access to the storage unit when the judging unit judges the requisition does not satisfy the access condition. The terminal device includes: a record carrier interface operable to attach the record carrier thereto; an access requisition generation unit operable to generate the requisition of the record carrier to the storage unit; and an access requisition output unit operable to output, to the record carrier, the generated requisition for access. The access condition management server connected, via a network, with the terminal device having the record carrier attached thereto, includes: an access condition storage unit operable to store the access condition; and an access condition transmission unit operable to transmit the access condition to the record carrier via the terminal device having the record carrier attached thereto.

Namely, according to this structure, it is not the record carrier itself but the access condition management server that stores the access condition. Herewith, even if the record carrier is lost with attached to the authorized terminal device, the access condition stored by the access condition management server can be rewritten so that the terminal device having the record carrier attached thereto cannot access the storage area.

### BRIEF DESCRIPTION OF THE DRAWINGS

FIG. 1 shows a structure of a data protection system 1;

FIG. 2 is a functional block diagram showing a structure of a record carrier 10;

FIG. 3 shows an internal structure of an access-limited area 13;

FIG. 4 is a functional block diagram showing a structure of a device information registration unit 14;

FIG. 5A shows a data structure of registration requisition data 120, FIG. 5B shows a data structure of a registration ID list 125, FIG. 5C shows a data structure of deletion requisition data 130, and FIG. 5D shows a data structure of a deletion ID list 135;

FIG. 6 shows a data structure of an access authorized device table 140;

FIG. 7 is a functional block diagram showing a structure of a controller 16;

FIGS. 8A-8D show data structures of access requisitions 160, 170, 180 and 190, respectively;

FIG. 9 shows a data structure of a table 200;

FIG. 10 is a functional block diagram showing a structure of a cellular phone 20;

FIG. 11 is a flowchart illustrating overall operations of the data protection system 1;

FIG. 12A is a flowchart illustrating operations of a registration process of device information, and FIG. 12B is a flowchart illustrating operations of a deletion process of device information;

FIG. 13 is a flowchart illustrating operations of a FIG. 14 is a flowchart illustrating operations of the registration process performed by the record carrier 10 (continuing to FIG. 15);

FIG. 15 is a flowchart illustrating operations of the registration process performed by the record carrier 10 (continued from FIG. 14);

FIG. 16 is a flowchart illustrating operations of the registration process performed by the cellular phone 20 (continuing to FIG. 17);

FIG. 17 is a flowchart illustrating operations of the registration process performed by the cellular phone 20 (continued from FIG. 16);

FIG. 18 is a flowchart illustrating operations of the deletion process performed by the record carrier 10 (continuing to FIG. 19);

FIG. 19 is a flowchart illustrating operations of the deletion process performed by the record carrier 10 (continued from FIG. 18);

FIG. 20 is a flowchart illustrating operations of the deletion process performed by the cellular phone 20;

FIG. 21 is a flowchart illustrating operations of a data access process performed by the data protection system 1;

FIG. 22 is a flowchart illustrating operations of an access authorization process performed by the record carrier FIG. 23 is a flowchart illustrating operations of the access authorization process performed by the record carrier 10 (continued from FIG. 22);

FIG. 24 shows a structure of a data protection system 1a;

FIG. 25 is a functional block diagram showing a structure of a record carrier 10a;

FIG. 26 is a functional block diagram showing a structure of a cellular phone 20a and a registration server 60a;

FIG. 27A shows a data structure of registration requisition data 310, and FIG. 27B shows a data structure of deletion requisition data 320;

FIG. 28 shows a structure of a data protection system 2;

FIG. 29 is a functional block diagram showing a structure of a record carrier 10b and a management server 70b;

FIG. 30 shows a data structure of an access authorized device table 400;

FIG. 31 is a flowchart illustrating overall operations of the data protection system 2; and

FIG. 32 is a flowchart illustrating operations of the data access process in the data protection system 2.

### BEST MODE FOR CARRYING OUT THE INVENTION

### [1] First Embodiment

The following gives a description of a data protection system 1 according to the first embodiment of the present invention.

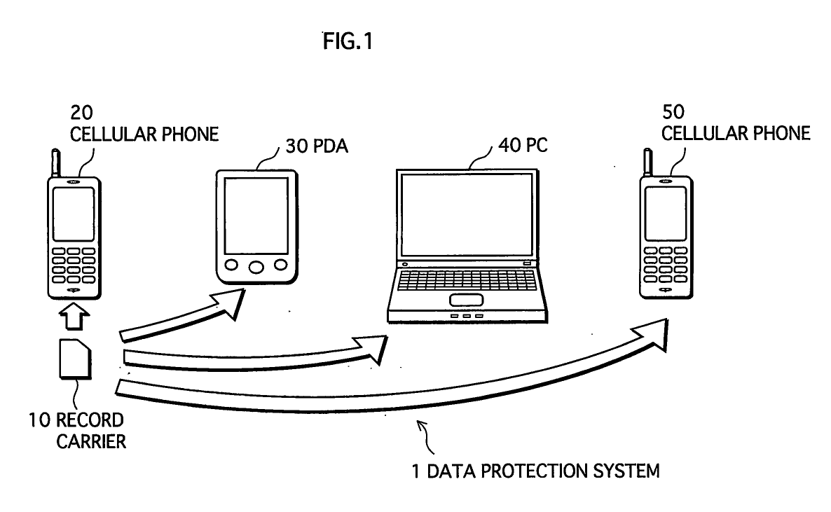

FIG. 1 shows a structure of the data protection system 1. As shown in the figure, the data protection system 1 comprises a record carrier 10, a cellular phone 20, a PDA (Personal Digital Assistant) 30, a PC (Personal Computer) 40 and a cellular phone 50.

The record carrier 10 is a portable medium having a microprocessor therein. Here, it is assumed that the record carrier 10 is a memory card, an IC card or the like, which is, for use, placed in a card slot of for example a cellular phone, a PDA, a PC, a digital camera, and a card reader/writer.

A SD (Secure Digital) memory card is an example of the memory card. SD memory cards have a function of copyright protect called CPRM (Content Protection for Recordable Media) built-in, and are suited for storing contents such as music and images.

A SIM (Subscriber Identity Module) card is an example of the IC card. Cellular phone companies issue-SIM cards which are IC cards each containing the contractant's information. The SIM cards are attached to cellular phones and used for user identification. By detaching the SIM card from one cellular phone and placing it in another, a plurality of cellular phones can be used under the name of the same contractant.

The cellular phone 20, PDA 30, PC 40, and cellular phone 50 are computer systems each having a microprocessor. In this specification, these cellular phones, PDA and PC will be sometimes collectively called “terminal devices.”

These terminal devices each have a card slot, and input and output information to/from the record carrier 10 when the record carrier 10 is placed in the card slot. To each of the terminal devices, a device ID that is a specific identifier for the terminal device is assigned. Device IDs of “ID_A,” “ID_B,” “ID_C” and “ID_E” are assigned to the cellular phone 20, the PDA 30, the PC 40, and the cellular phone 50, respectively. The details will be discussed later in this specification.

Note here that the present embodiment assumes that the record carrier 10 was placed in the card slot of the cellular phone 20 in advance, and then has been sold to the user of the cellular phone 20 in this condition. Additionally, the cellular phone 20, PDA 30 and PC 40 shall be terminal devices all owned by the same user while the cellular phone 50 shall be a terminal device owned by another individual.

<Structure>

1. Record Carrier 10

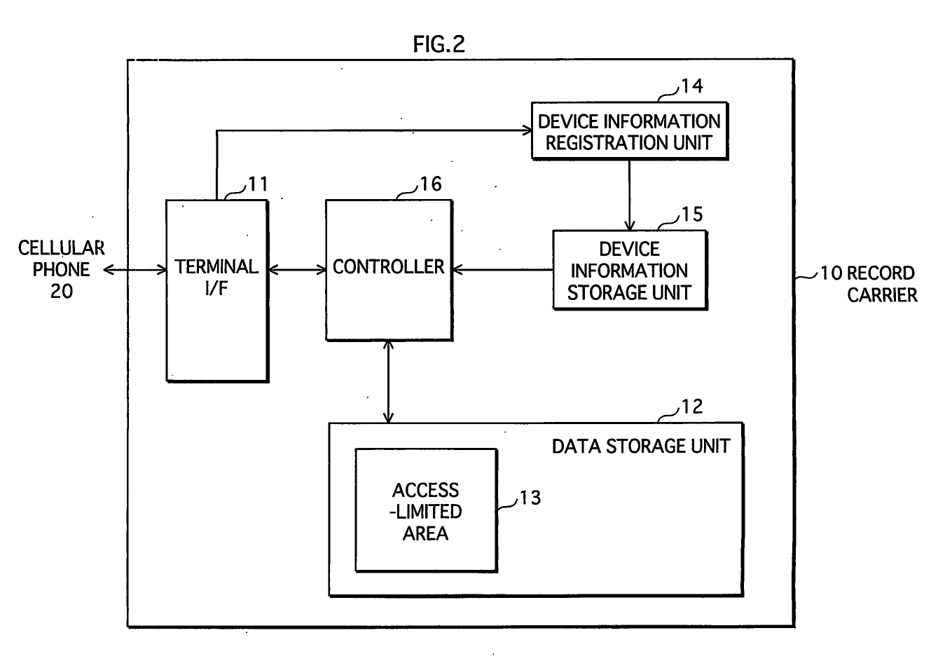

FIG. 2 shows a structure of the record carrier 10. As shown in the figure, the record carrier 10 comprises a terminal I/F 11, a data storage unit 12, a device information registration unit 14, a device information storage unit 15, and a controller 16. The data storage unit 12 includes an access-limited area 13.

1.1 Terminal I/F 11

The terminal I/F 11 comprises connector pins and an interface driver. When the record carrier 10 is placed in the card slot of the cellular phone 20, the PDA 30, the PC 40 or the cellular phone 50, the terminal I/F 11 receives and sends various information from/to the relevant terminal device.

Specifically speaking, for example the terminal I/F 11 outputs, to the controller 16, an access requisition received from the terminal device, and outputs, to the device information registration unit 14, registration requisition data and deletion requisition data received from the terminal device.

1.2 Data Storage Unit 12

The data storage unit 12 is specifically speaking a flash memory, and stores programs and data. The data storage unit 12 can be accessed from the controller 16, and is capable of storing therein information received from the controller 16 and outputting the stored information to the controller 16 according to a requisition from the controller 16. Note that the data storage unit 12 includes the access-limited area 13 which is an area used for storing highly confidential data and the like.

1.3 Access-Limited Area 13

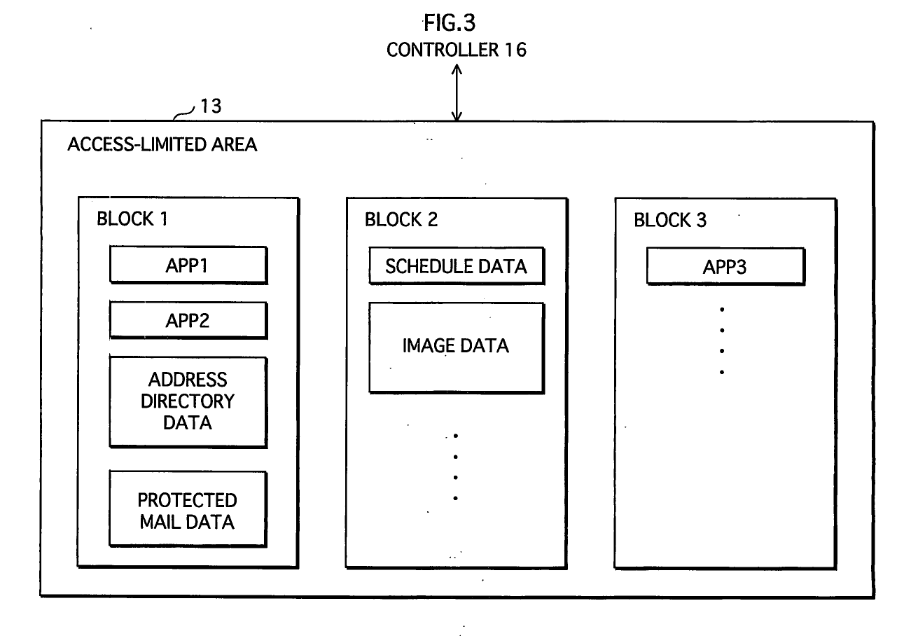

The access-limited area 13 is a part of the data storage unit 12, and comprises three memory blocks of Block 1, Block 2 and Block 3, as shown in FIG. 3. Memory areas of these memory blocks should be logically separated from one another, but there is no need to be physically separated.

Block 1 stores Application Program 1 (APP1), Application Program 2 (APP2), address directory data and protected mail data. Block 2 stores schedule data, image data and so on. Block 3 stores Application Program 3 (APP3) and the like.

These programs and data stored in each of the blocks are read out and written by the controller 16.

1.4 Device Information Registration Unit 14

The device information registration unit 14 comprises a microprocessor and the like, and registers access authorized device information with the device information storage unit 15 according to the registration requisition received from the cellular phone 20. The access authorized device information is information on terminal devices authorized to access the access-limited area 13. Furthermore, the device information registration unit 14 deletes already registered access authorized device information in the device information storage unit 15 according to the deletion requisition received from the cellular phone 20.

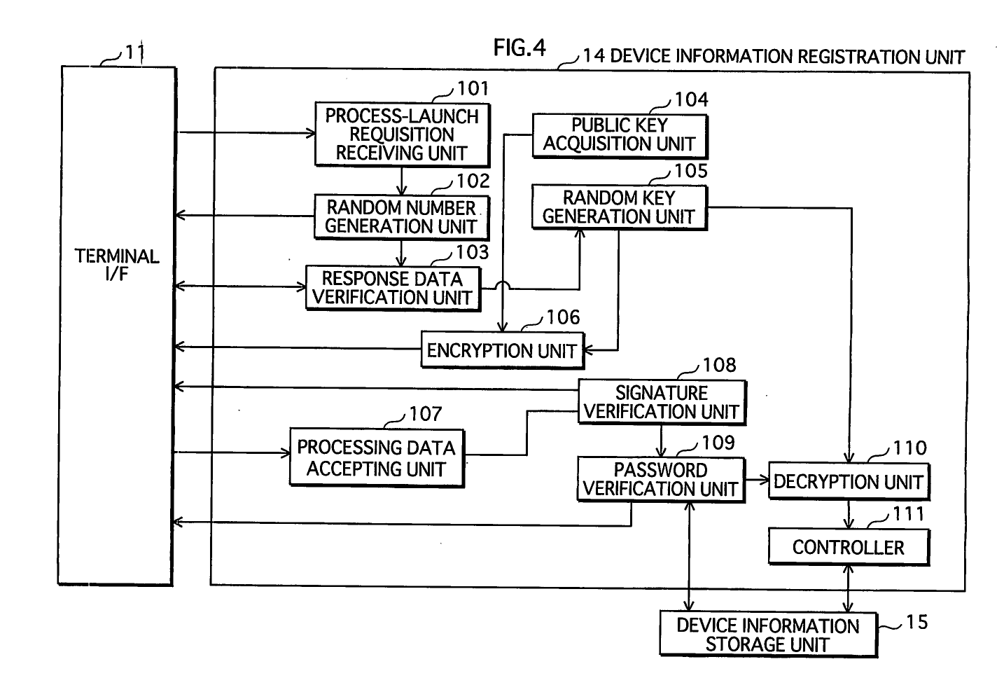

FIG. 4 is a functional block diagram showing a structure of the device information registration unit 14. As shown in the figure, the device information registration unit 14 comprises a process-launch requisition receiving unit 101, a random number generation unit 102, a response data verification unit 103, a public key acquisition unit 104, a random key generation unit 105, an encryption unit 106, processing-data accepting unit 107, a signature verification unit 108, a password verification unit 109, a decryption unit 110, and a data controller 111.

(a) The process-launch requisition receiving unit 101 receives a process-launch requisition from the cellular phone 20 via the terminal I/F 11. The process-launch requisition is information indicating a launch of a registration process or a deletion process of the access authorized device information. When receiving the process-launch requisition, the process-launch requisition receiving unit 101 outputs an instruction to the random number generation unit 102 to generate a random number.

(b) When receiving the instruction for generating a random number from the process-launch requisition receiving unit 101, the random number generation unit 102 generates a random number r. The random number r is challenge data used for a challenge/response verification performed with the cellular phone 20. The random number generation unit 102 outputs the generated random number r to the cellular phone 20 via the terminal I/F 11 as well as to the response data verification unit 103.

(c) The response data verification unit 103 shares in advance a common-key Kc and an encryption algorithm E₁ with the cellular phone 20. The response data verification unit 103 examine response data received from the cellular phone 20 via the terminal I/F 11 and fudges whether or not the cellular phone 20 is an authorized terminal device.

Specifically speaking, the response data verification unit 103 receives the random number r, which is challenge data, from the random number generation unit 102, and generates encrypted data C₁=E₁ (Kc, r) by applying the encryption algorithm E₁ to the received random number r using the common key Kc as an encryption key. Meanwhile, the response data verification unit 103 receives response data C₁′=E₁ (Kc, r) from the cellular phone 20 via the terminal I/F 11. Then, the response data verification unit 103 compares the encrypted data C₁ and the response data C₁′. When these two match, the response data verification unit 103 confirms that the cellular phone 20 is an authorized terminal device, and gives an instruction to the random key generation unit 105 to generate a random key. When C₁ and C₁′ do not match, the response data verification unit 103 confirms that the cellular phone 20 is an unauthorized terminal device and is sends an error message indicating “an authorization error” to the cellular phone 20 via the terminal I/F 11. The encryption algorithm E₁ is not confined to any particular algorithms, but one example of this is the DES (Data Encryption Standard).

(d) The public key acquisition unit 104 acquires and holds a public key PK₂₀ of the cellular phone 20. Here, no restrictions on how to acquire the public key PK₂₀ are set. The public key PK₂₀ may be written to the public key acquisition unit 104 in advance, or may be acquired from the cellular phone 20 via the terminal I/F 11 according to, for example, the user operation. The public key acquisition unit 104 receives an instruction from the encryption unit 106 and outputs the public key PK₂₀ to the encryption unit 106.

(e) When receiving, from the response data verification unit 103, the instruction to generate a random key, the random key generation unit 105 generates a random key Kr. The random key generation unit 105 outputs the generated random key Kr to the encryption unit 106 as well as to the decryption unit 110.

Note that in this specification random keys generated by the random key generation unit 105 are all denoted as “Kr,” however an actual random key Kr is key data randomly generated every time when the random key generation unit 105 receives, from the response data verification unit 103, an instruction to generate a random key.

(f) The encryption unit 106 receives the random key Kr from the random key generation unit 105. When receiving the random key Kr, the encryption unit 106 directs the public key acquisition unit 104 to output the public key PK₂₀, and receives the public key PK₂₀ from the public key acquisition unit 104.

The encryption unit 106 generates an encrypted random key C₂=E₂(PK₂₀, Kr) by applying an encryption algorithm E₂ to the random key Kr using the public key PK₂₀ as an encryption key. The encryption unit 106 outputs the generated encrypted random key C₂=E₂ (PK₂₀, Kr) to the cellular phone 20 via the terminal I/F 11. Here, the encryption algorithm E₂ is not confined to any particular algorithms, but one example of this is the RSA (Rivest-Shamir-Adleman) algorithm.

(g) The processing-data accepting unit 107 receives processing data from the cellular phone 20 via the terminal I/F 11, and outputs the received processing data to the signature verification unit 108.

The processing data received by the processing-data accepting unit 107 from the cellular phone 20 is registration requisition data or deletion requisition data. While the registration requisition data indicates the registration process of the access authorized device information, the deletion requisition data indicates the deletion process of the access authorized device information.

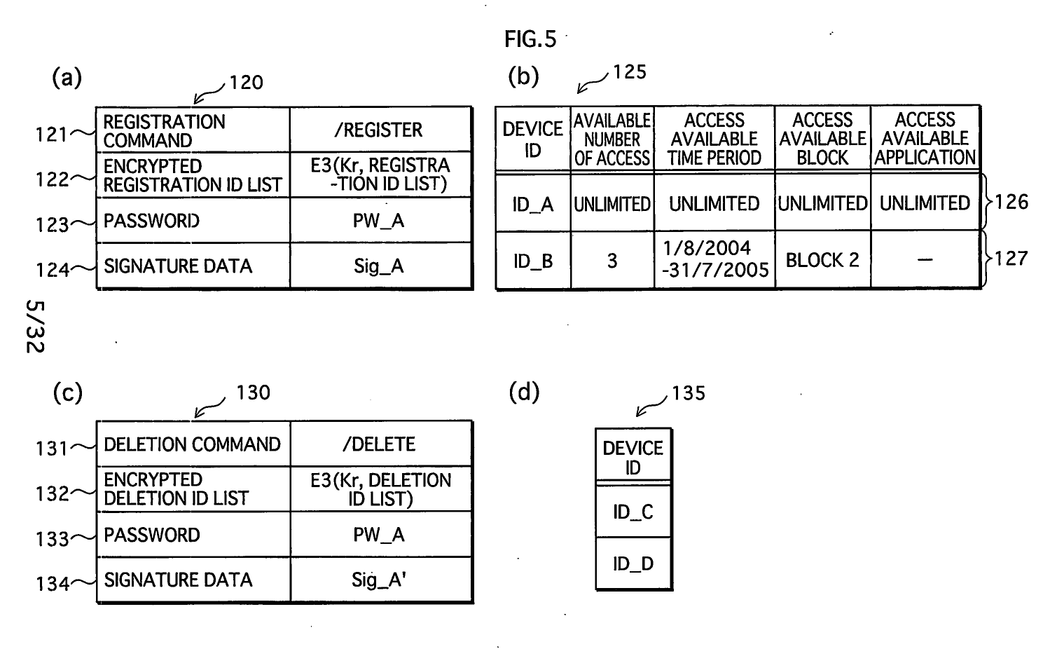

FIG. 5A shows an example of the registration requisition data. The registration requisition data 120 comprises a registration command 121, an encrypted registration ID list 122, a password 123, and signature data 124.

The registration command 121 is a command directing the data controller 111, described hereinafter, to perform the registration process. Here, “/register” is given as a specific example of the registration command 121.

The encrypted registration ID list 122 is encrypted data which is generated by applying an encryption algorithm E₃ to the registration ID list 125 shown in FIG. 5B using the random key Kr as an encryption key. Here, the encrypted registration ID list 122 is denoted as E₃(Kr, registration ID list).

As shown in FIG. 5B, the registration ID list 125 comprises sets of registration information 126 and 127. Each set of the registration information comprises a device ID, an available number of accesses, an access available time period, access available blocks and access available applications.

The password 123 is data entered by the user of the cellular phone 20.

The signature data 124 is signature data generated by applying a digital signature algorithm to the registration command 121, the encrypted registration ID list 122 and the password 123 using a signature key. Here, the signature key is key data for the digital signature, held by the cellular phone 20.

The registration requisition data 120 is data generated by the controller 23 of the cellular phone 20. Accordingly, the details of the registration requisition data 120 and registration ID list 125 will be discussed later in the description of the cellular phone 20.

FIG. 5C shows an example of the deletion requisition data. The deletion requisition data 130 comprises a deletion command 131, an encrypted deletion ID list 132, a password 133, and signature data 134.

The deletion command 131 is a command directing the data controller 111, described hereinafter, to perform the deletion process. Here, “/delete” is given as a specific example of the deletion command 131.

The encrypted deletion ID list 132 is encrypted data which is generated by applying the encryption algorithm E₃ to a deletion ID list 135 shown in FIG. 5D using the random key Kr as an encryption key. Here, the encrypted deletion ID list 132 is denoted as E₃(Kr, deletion ID list). The deletion ID list 135 comprises device IDs of “ID_C” and “ID_D.”

The password 133 is data entered by the operator of the cellular phone 20.

The signature data 134 is signature data generated by applying a digital signature algorithm to the deletion command 131, the encrypted deletion ID list 132, and the password 133 using a signature key.

Here, the random key Kr is key data randomly generated in the random key generation unit 105 for each process, as described above. Therefore, the random key used for generating the encrypted registration ID list 122 is different from the one used for generating the encrypted registration ID list 132.

Note that the deletion requisition data 130 is data generated by the controller, 23 of the cellular phone 20. Accordingly, the details of the deletion requisition data 130 will be discussed later in the description of the cellular phone 20.

(h) The signature verification unit 108 holds a verification key therein in advance. The verification key corresponds to the signature key held by the cellular phone 20, and is key data used to verify the signature data outputted from the cellular phone 20.

The signature verification unit 108 receives the processing data from the processing-data accepting unit 107, examines the legitimacy of the signature data included in the received processing data, and judges whether or not the processing data is indeed data generated by the cellular phone 20.

When the legitimacy of the signature data is verified, the signature verification unit 108 outputs the processing data to the password verification unit 109. Contrarily, if the legitimacy of the signature data is not verified, the signature verification unit 108 informs cellular phone 20 accordingly via the terminal I/F 11 and discards the processing data.

To give a specific example, suppose that the processing data received from the processing data accepting unit 107 is the registration requisition data 120 shown in FIG. 5A. The signature verification unit 108 examines the legitimacy of the signature data “Sig_A” using the verification key. When the legitimacy of the signature data “Sig_A” is verified, the signature verification unit 108 outputs the registration requisition data 120 to the password verification unit 109. If the processing data received from the processing-data accepting unit 107 is the deletion requisition data 130 shown in FIG. 5C, the signature verification unit 108 examines the legitimacy of the signature data “Sig_A′” using the verification key. When the legitimacy of the signature data “Sig_A′” is verified, the signature verification unit 108 outputs the deletion requisition data 130 to the password verification unit 109.

The algorithm used in the signature verification unit 108 for verifying signatures is a digital signature standard using a public-key encryption scheme. The explanation for this algorithm is omitted-since it is feasible with a well-known technology.

(i) The password verification unit 109 receives the processing data from the signature verification unit 108. Furthermore, the password verification unit 109 reads out a correct password from the device information storage unit 15, and judges whether or not the password included in the processing data matches the correct password.

When the password included in the processing data, namely the password entered by the operator of the cellular phone 20, matches the correct password, the password verification unit 109 outputs the processing data to the decryption unit 110. If the password included in the processing data does not match the correct password, the password verification unit 109 informs the cellular phone 20 accordingly via the terminal I/F 11 and discards the processing data.

To give a specific example, suppose that the processing data received from the signature verification unit 108 is the registration requisition data 120 shown in FIG. 5A. The password verification unit 109 extracts “PW_A” from the registration requisition data 120, and judges whether or not “PW_A” matches the correct password. When “PW_A” matches the correct password, the password verification unit 109 outputs the registration requisition data 120 to the decryption unit 110. If the processing data received from the signature verification unit 108 is the deletion requisition data 130 shown in FIG. 5C, the password verification unit 109 extracts “PW_A′” and judges whether or not “PW_A′” matches the correct password. When “PW_A′” matches the correct password, the password verification unit 109 outputs the deletion requisition data 130 to the decryption unit 110.

(j) The decryption unit 110 receives the processing data from the password verification unit 109 and further receives the random key Kr from the random key generation unit 105.

The decryption unit 110 extracts the encrypted processing data, and decrypts the encrypted registration ID list or the encrypted deletion ID list by applying a decryption algorithm D₃ using the random key Kr received from the random key generation unit 105 as a decryption key in order to obtain the registration ID list or the deletion ID list. Here, the decryption algorithm D₃ is an algorithm used for decrypting data which has been encrypted with the encryption algorithm E₃.

The decryption unit 110 outputs, to the data controller 111, the registration command and the decrypted registration ID list, or the deletion command and the decrypted deletion ID list.

To give a specific example, when receiving the registration requisition data 120 from the password verification unit 109, the decryption unit 110 extracts the encrypted registration ID list 122 from the registration requisition data 120, and decrypts the encrypted registration ID list 122 in order to obtain the registration ID list 125 shown in FIG. 5B. The decryption unit 110 outputs the registration command 121 and the registration ID list 125 to the data controller 111.

When receiving the deletion requisition data 130 from the password verification unit 109, the decryption unit 110 extracts the encrypted deletion ID list 132 from the deletion requisition data 130, and decrypts the encrypted deletion ID last 132 in order to obtain the deletion ID list 135 shown in FIG. 5D. The decryption unit 110 outputs the deletion command 131 and the deletion ID list 135 to the data controller 111.

(k) The data controller 111 performs registration and deletion of the access authorized device information.

More specifically, the data controller 111 receives the registration command and the registration ID list from the decryption unit 110. If the registration information included in the registration ID list has not yet been registered with an access authorized device table 140 stored in the device information storage unit 15, the data controller 111 registers the registration information with the access authorized device table 140 as access authorized device information.

The data controller 111 also receives the deletion command and the deletion ID list from the decryption unit 110. If the device ID included in the deletion ID list has already been registered with the access authorized device table 140, the data controller 111 deletes the access authorized device information which includes the device ID from the access authorized device table 140.

Note that the access authorized device table 140 will be described later.

1.5 Device Information Storage Unit 15

The device information storage unit 15 stores a password and the access authorized device table 140.

It is assumed that the password stored in the device information storage unit 15 is a unique password set at the time when the record carrier 10 is manufactured or shipped and written to the device information storage unit 15.

Note that only the user who has purchased the record carrier 10 shall know the password stored in the device information storage unit 15. For example, the following scheme may be adopted: within the packaging box, the password stored in the device information storage unit 15 is written in a place that cannot be seen unless the packaging box is opened. In this case, the user cannot obtain the password until the/she purchases the record carrier 10 and then opens the packaging box.

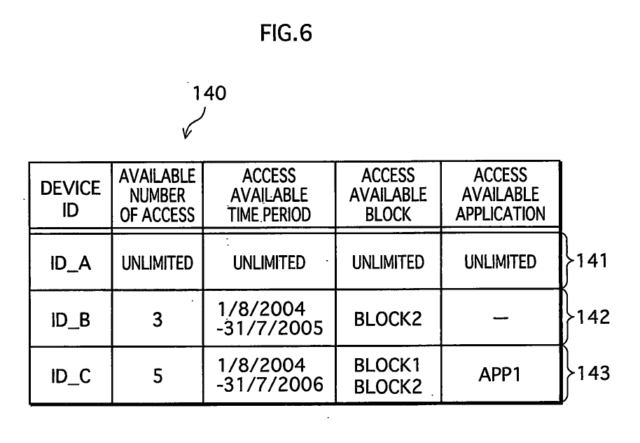

FIG. 6 shows a data structure of the access authorized device table 140. The access authorized device table 140 comprises sets of access authorized device information 141, 142 and 143, each of which includes a device ID, an available number of accesses, an access available time period, access available blocks, and access available applications.

The device ID is an identifier by which a device authorized to access the access-limited area 13 of the data storage unit 12 can be uniquely identified. The available number of accesses is the number of times that the corresponding device is authorized to access the access-limited area 13. The access available time period is a time period during which the corresponding device is authorized to access the access-limited area 13. The access available blocks are, within the access-limited area 13, memory blocks that the corresponding device is authorized to access. The access available applications are application programs that the corresponding device is authorized to access.

According to FIG. 6, devices authorized to access the access-limited area 13 are those, respectively having a device ID of “ID_A,” a device ID of “ID_B” and a device ID of “ID_C.”

According to the access authorized device information 141, the device having the device ID “ID_A” (cellular phone 20) is “unlimited” in all respects, i.e. the available number of accesses, the access available time period, the access available blocks and the access available applications. Therefore, this device is authorized to access the access-limited area 13 without any restriction.

The access authorized device information 142 indicates that the device having the device ID “ID_B” (PDA 30) has: “3” in the available number of accesses, “Jan. 8, 2004-Jul. 31, 2005” in the access available time period, “Block 2? in the access available blocks, and “-” in the access available applications. Therefore, this device is authorized to access only Block 2 up to three times during the time period between Aug. 1, 2004 and Jul. 31, 2005.

The access authorized device information 143 indicates that the device having the device ID “ID_C” (PC 40) has: “5”in the available number of accesses, “Aug. 1, 2004-Jul. 31, 2006” in the access available time period, “Block 1 and Block 2” in the access available blocks, and “APP1” in the access available applications. Therefore, this device is authorized to access only Blocks 1 and 2 up to five times during the time period between Aug. 1, 2004 and Jul. 31, 2006, provided that the application program which the device is authorized to access is only the Application Program 1 (APP1).

Each set of the access authorized device information is registered with or deleted from the access authorized device table 140 by the device information registration unit 14. Additionally, each set of the access authorized device information is used by the controller 16 for access authorization which is implemented in response to an access requisition.

1.6 Controller 16

The controller 16 comprises a microprocessor and the like. When receiving, from the terminal I/F 11, the access requisition to the access-limited area 13, the controller 16 refers to the access authorized device table 140 stored in the device information storage unit 15, and judges whether to allow access to the access-limited area 13 in response to the access requisition. The following will give a detailed description of the controller 16.

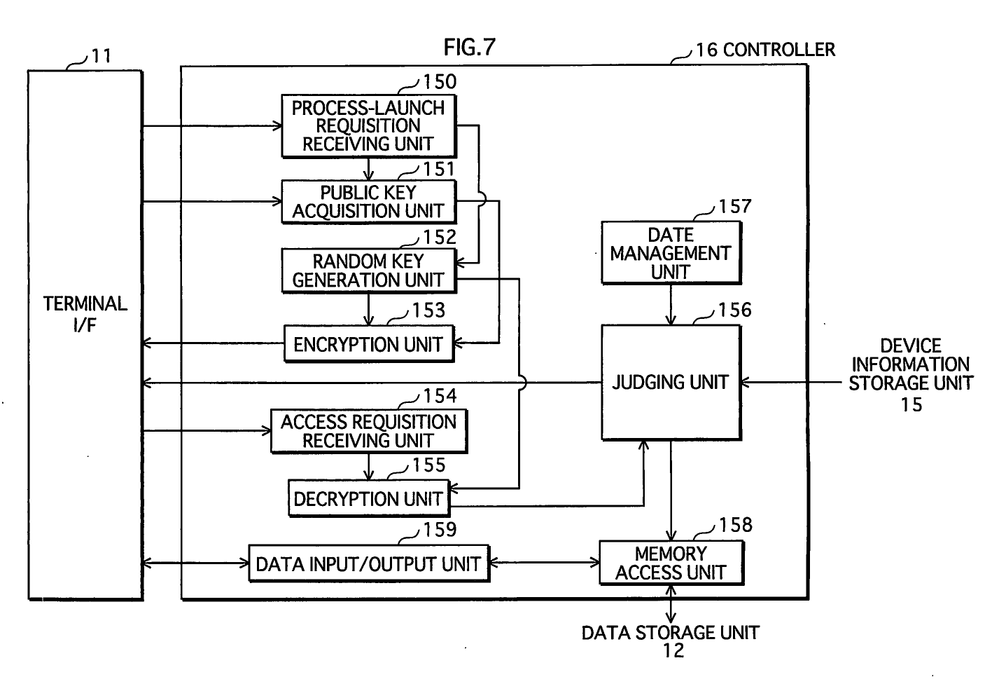

FIG. 7 is a functional block diagram illustrating a structure of the controller 16. As shown in the figure, the controller 16 comprises a process-launch requisition receiving unit 150, a public key acquisition unit 151, a random key generation unit 152, an encryption unit 153, an access requisition receiving unit 154, a decryption unit 155, a judging unit 156, a date management unit 157, a memory access unit 158 and a data input/output unit 159.

(a) The process-launch requisition receiving unit 150 receives a process-launch requisition, via the terminal I/F 11, from a terminal device having the record carrier 10 attached thereto. The process-launch requisition is information indicating a launch of the access requisition process to the access-limited area 13. When receiving the process-launch requisition, the process-launch requisition receiving-unit 150 outputs an instruction to the public key acquisition unit 151 to acquire the public key of the terminal device as well as an instruction to the random key generation unit 152 to generate a random key.

(b) When receiving the instruction to acquire the public key from the process-launch requisition receiving unit 150, the public key acquisition unit 151 acquires the public key PKN of the terminal device, via the terminal I/F 11, from the terminal device having the record carrier 10 attached thereto, where N=20, 30, 40 or 50. PK₂₀, PK₃₀, PK₄₀ and PK₅₀ are public keys of the cellular phone 20, the PDA 30, the PC 40 and the cellular phone 50, respectively. In the case where the record carrier 10 is placed in the card slot of, for example, the cellular phone 20, the public key acquisition unit 151 acquires the public key PK₂₀ from the cellular phone 20. The public key acquisition unit 151 outputs the acquired public key PKN to the encryption unit 153.

(c) When receiving, from the process-launch requisition receiving unit 150, the instruction to generate a random key, the random key generation unit 152 generates a random key Kr. The random key generation unit 152 outputs the generated random key Kr to the encryption unit 153 as well as to the decryption unit 155.

(d) The encryption unit 153 receives the public key PK_{N} from the public key acquisition unit 151 and the random key Kr from the random key generation unit 152. The encryption unit 153 generates an encrypted random key C₄=E₄ (PK_{N}, Kr) by applying an encryption algorithm E₄ to the random key Kr using public key PK_{N} as an encryption key. The encryption unit 153 outputs the encrypted random key C₄=E₄ (PK_{N}, Kr) to the terminal device via the terminal I/F 11. In the case where the record carrier 10 is placed in the card slot of, for example, the cellular phone 20, the encryption unit 153 generates the encrypted random key C₄=E₄(PK₂₀, Kr), and outputs the encrypted random key C₄ to the cellular phone 20 via the terminal I/F 11.

The encryption algorithm C₄ is not confined to any particular algorithm, but one example of this is the RSA.

(e) When receiving an access requisition from the terminal device via the terminal I/F 11, the access requisition receiving unit 154 outputs the received access requisition to the decryption unit 155.

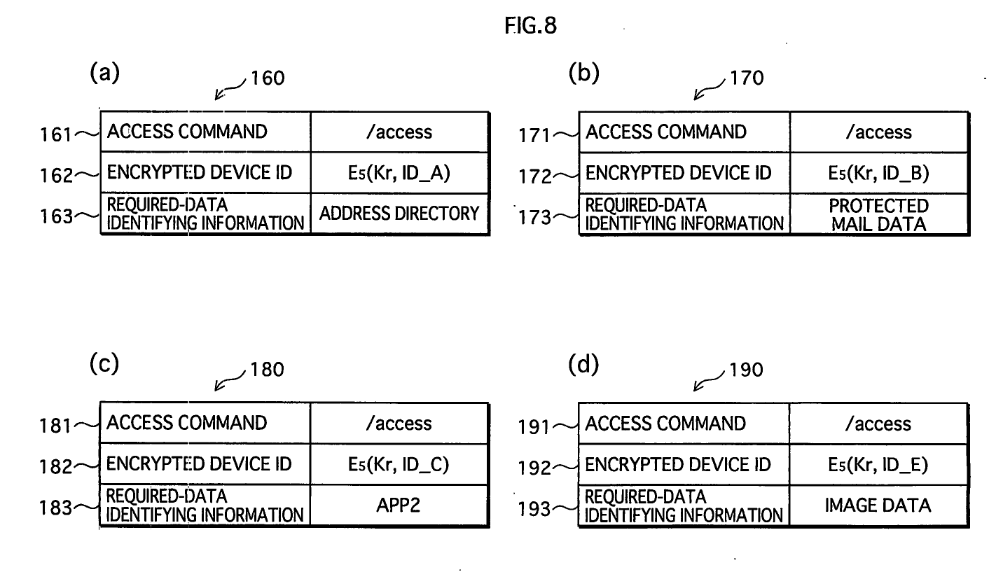

FIG. 8A shows an example of the access requisition received by the access requisition receiving unit 154 from the cellular phone 20. The access requisition 160 comprises an access command 161, an encrypted device ID 162 and required-data identifying information 163.

Similarly, FIG. 8B shows an example of an access requisition 170 received from the PDA 30. FIG. 8C shows an example of an access requisition 180 received from the PC 40. FIG. 8D shows an example of an access requisition 190 received from the cellular phone 50.

Such an access requisition is data generated by each of the terminal devices. Accordingly, detailed explanations of the access requisitions 160, 170, 180 and 190 will be respectively given later.

(f) The decryption unit 155 receives the random key Kr from the random key generation unit 152 and the access requisition from the access requisition receiving unit 154. The decryption unit 155 extracts an encrypted device ID from the access requisition, and decrypts the encrypted device ID by applying a decryption algorithm D₅ using the random key Kr as a decryption algorithm D₅ is an algorithm used for decrypting data which has been encrypted with the encryption algorithm E₅. The decryption unit 155 outputs, to the judging unit 156, the access command, the decrypted device ID and the required-data identifying information.

To give a specific example, when receiving the access requisition 160 shown in FIG. 8A from the access requisition receiving unit 154, the decryption unit 155 extracts an encrypted device ID 162 “E₅(Kr, ID_A)” from the access requisition 160, and decrypts the encrypted device ID 162 by applying the decryption algorithm D₅ using the random key Kr as a decryption key in order to obtain “ID_A.” The decryption unit 155 outputs, to the judging unit 156, the access command 161 “/access,” the device ID “ID_A” and the required-data identifying information 163 “address directory.”

(g) The judging unit 156 receives the access command, the device ID and the required-data identifying information from the decryption unit 155. The judging unit 156 judges whether or not the terminal device having the received device ID is authorized to, access data identified by the received required-data identifying information.

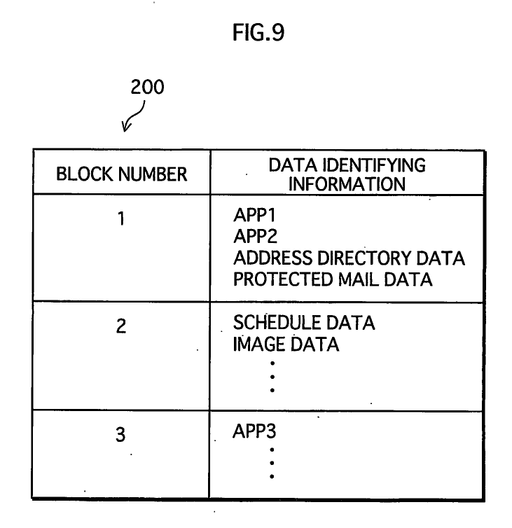

Additionally, the judging unit 156 stores a table 200 shown in FIG. 9. The table 200 is a table showing the correspondence between block numbers of memory blocks in the access-limited area 13 and data identifying information of data stored in the respective memory blocks. The judging unit 156 also stores a table showing the correspondence between device IDs and their number of times already accessed. The number of times already accessed is the number of times that a terminal device having the corresponding device ID has accessed the access limiting area 13. Note that this table is not illustrated.

The following will describe access authorization performed by the judging unit 156, with the use of specific examples.

The judging unit 156 receives, from the decryption unit 155, the access command 161 “/access,” “ID_A” decrypted by the decryption unit 155, and the required-data identifying information 163 “address directory.” The judging unit 156 reads out, from the access authorized device table 140 stored in the device information storage unit 15, access authorized device information 141 which includes the device ID “ID_A.” Furthermore, the judging unit 156 reads out date information indicating the current date from the date management unit 157.

From the access authorized device information 141, the date information and the table 200, the judging unit 156 judges whether or not the cellular phone 20 having the device ID “ID_A” is authorized to access “address directory.” The authorization process will be discussed in detail later.

Here, the cellular phone 20 is authorized to access to the address directory. Therefore, the judging unit 156 directs the memory access unit 158 to read out the address directory data (FIG. 3) from the access-limited area 13 and output the address directory data to the cellular phone 20 via the data input/output unit 159.

Here, if the cellular phone 20 is not authorized to access the address directory, the judging unit 156 outputs, to the cellular phone 20 via the terminal I/F 11, an error message informing that the cellular phone 20 is not authorized to access the specified data.

(h) The date management unit 157 manages date information indicating the current date.

(i) The memory access unit 158 stores the correspondence between the data identifying information and memory addresses, each of which indicates a location within the data storage unit 12 which stores data identified by the data identifying information. When receiving the access command and the data identifying information from the judging unit 156, the memory access unit 158 acquires a memory address corresponding to the received data identifying information. The memory access unit 158 reads out data from the location indicated by the acquired memory address, and outputs the readout data to the data input/output unit 159.

(j) The data input/output unit 159 exchanges information between the terminal I/F 11 and the memory access unit 158.

2. Cellular Phone 20

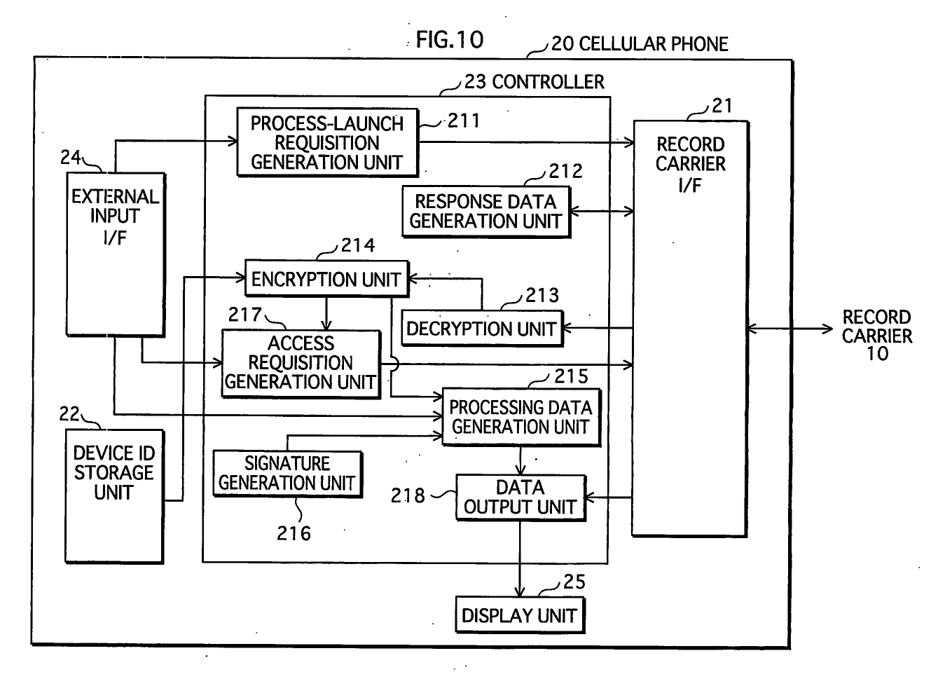

FIG. 10 is a functional black diagram illustrating a structure of the cellular phone 20. As shown in the figure, the cellular phone 20 comprises a record carrier I/F 21, a device ID storage unit 22, a controller 23, an external input I/F 24 and a display unit 25.

Specifically speaking, the cellular phone 20 has an antenna, a radio communication unit, a microphone, a speaker and so on, and is a mobile phone establishing radio communication. Since such functions as a cellular phone are feasible with a well-known technology, these components are omitted from FIG. 10.

2.1 Record Carrier I/F 21

The record carrier I/F 21 comprises a memory card slot and such, and receives and sends various information from/to the record carrier 10 placed in the memory card slot.

2.2 Device ID Storage Unit 22

The device ID storage unit 22 stores the device ID “ID_A” by which the cellular phone 20 is uniquely identified. Specifically speaking a serial number or a telephone number is used as the device ID.

2.3 Controller 23

As shown in FIG. 10, the controller 23 comprises a process-launch requisition generation unit 211, a response data generation unit 212, a decryption unit 213, an encryption unit 214, a processing data generation unit 215, a signature generation unit 216, an access requisition generation unit 217 and a data output unit 218.

(a) When receiving, from the external input I/F 24, an input signal indicating a registration requisition, a deletion requisition, or a data access requisition, the process-launch requisition generation unit 211 generates a process-launch requisition, and outputs the generated process-launch requisition to the record carrier 10 via the record carrier I/F 21.

(b) The response data generation unit 212 shares the common key Kc and the encryption algorithm E₁ with the record carrier 10 in advance.

The response data generation unit 212 receives, from the record carrier 10 via the record carrier I/F 21, the random number r which is the challenge data, and generates the response data C₁′=E₁(Kc, r) by applying the encryption algorithm E₁ to the received random number r using the common key Kc as an encryption key. The response data generation unit 212 outputs the generated response data C₁′ to the record carrier 10 via the record carrier I/F 21.

(c) The decryption unit 213 holds in confidence a secret key SK₂₀ corresponding to the public key PK₂₀.

In the registration and deletion processes, the decryption unit 213 receives the encrypted random key C₂=E₂(PK₂₀, Kr) from the record carrier 10 via the record carrier I/F 21. The encrypted random key C₂=E₂(PK₂₀; Kr) is data in which the random key Kr has been encrypted with the public key PK₂₀ of the cellular phone 20. The decryption unit 213 decrypts the encrypted random key C₂ by applying a decryption algorithm D₂ using the secret key SK₂₀ as a decryption key in order to obtain the random key Kr. Here, the decryption algorithm D₂ is an algorithm used for decrypting data which has been encrypted with the encryption algorithm E₂. The decryption unit 213 outputs the decrypted random key Kr to the encryption unit 214.

In the access requisition process, the decryption unit 213 receives the encrypted random key C₄=E₄(PK₂₀, Kr) from the record carrier 10 via the record carrier I/F 21. The encrypted random key C₄=E₄(PK₂₀, Kr) is data in which the random key Kr has been encrypted with the public key PK₂₀ of the cellular phone 20. The decryption unit 213 decrypts the encrypted random key C₄ by applying the decryption algorithm D₄ using the secret key SK₂₀ as a decryption key in order to obtain the random key Kr. Here, the decryption algorithm D₄ is an algorithm used for decrypting data which has been encrypted with the encryption algorithm E₄. The decryption unit 213 outputs the decrypted random key Kr to the encryption unit 214.

(d) In the registration process, the encryption unit 214 receives the registration ID list from the processing data unit 213. The encryption unit 214 generates an encrypted registration ID list by applying the encryption algorithm E₃ to the registration ID list using the random key Kr as an encryption key. Specifically speaking, the encryption unit 214 receives the registration ID list 125 shown in FIG. 5B from the processing data generation unit 215, and generates the encrypted registration ID list by encrypting the registration ID list 125. The encryption unit 214 outputs the encrypted registration ID list to the processing data generation unit 215.

Similarly, in the deletion process, the encryption unit 214 generates an encrypted deletion ID list by encrypting the deletion ID list. Specifically speaking, the encryption unit 214 receives the deletion ID list 135 shown in FIG. 5D from the processing data generation unit 215, and generates the encryption deletion list by encrypting the deletion ID list 135. The encryption unit 214 outputs the encrypted deletion ID list to the processing data generation unit 215.

In the access requisition process, the encryption unit 214 reads out the device ID “ID_A” from the device ID storage unit 22, and further receives the random key Kr from the decryption unit 213. The encryption unit 214 generates the encrypted device ID “E₅ (Kr, ID_A)” by applying the encryption algorithm E₅ to “ID_A” using the random key Kr as an encryption key, and outputs the encrypted device ID to the access requisition generation unit 217.

(e) The processing data generation unit 215 generates registration requisition data and deletion requisition data.

(e-1) Generating Registration Requisition Data 120

Here, a process of generating the registration requisition data 120 shown in FIG. 5A is described as a specific example.

The processing data generation unit 215 holds in advance control information on the registration requisition data therein. The control information is used for generating the registration requisition data. In the control information, only the registration command 121 “/register” of the registration requisition data 120 is written and the encrypted registration ID list 122, the password 123 and the signature data 124 are all blanks. The processing data generation unit 215 receives the device ID of its own terminal device, “ID_A,” from the device ID storage unit 22. The processing data generation unit 215 accepts, via the external input I/F 24, inputs of information on the its own terminal-device: “unlimited” for the available number of accesses, “unlimited” for the access available time period, “unlimited” for the access available blocks, and “unlimited” for the access available applications, and generates the registration information 126.

Furthermore, the processing data generation unit 215 accepts, via the external input I/F 24, inputs of information on the PDA 30: “ID_B” for the device ID, “3” for the available number of accesses, “Jan. 8, 2004-Jun. 31, 2005” for the access available time period and “Block 2” for the access available blocks. Note here that an input of the access available applications of the PDA 30 is not accepted, or alternatively an input indicating that the PDA 30 does not have a right to access any applications is accepted. The processing data generation unit 215 generates the registration information 127 from the accepted information.

The processing data generation unit 215 generates the registration ID list 125 from the registration information 126 and 127. The processing data generation unit 215 outputs the generated registration ID list 125 to the encryption unit 214, and receives, from the encryption unit 214, the encrypted registration ID list 122 which is generated by encrypting the registration ID list 125.

The processing data generation unit 215 writes the encrypted registration ID list 122 into the control information on the registration requisition data.

The processing data generation unit 215 accepts an input of the password “PW_A” via the external input I/F 24, and writes the accepted password “PW_A” into the control information.

In addition, the processing data generation unit 215 receives the signature data “Sig_A” from the signature generation unit 216A, and write the received signature data “Sig_A” into the control information to generate the registration requisition data 120. The processing data generation unit 215 outputs the registration requisition data 120 to the record carrier 10 via the record carrier I/F 21.

(e-2) Generating Deletion Requisition Data 130

Here, a process of generating the deletion requisition data 130 shown in FIG. 5C is described as a specific example.

The processing data generation unit 215 holds in advance control information on the deletion requisition data therein. The control information is used for generating the deletion requisition data. In the control information, only the deletion command 131 “/delete” of the deletion requisition data 130 is written and the encrypted deletion ID list 132, the password 133 and the signature data 134 are all blanks.

The processing data generation unit 215 accepts inputs of the device IDs “ID_C” and “ID_D” from the external input I/F 24, and generates the deletion ID list 135 made up of “ID_C” and “ID_D.” The processing data generation unit 215 outputs the deletion ID list 135 to the encryption unit 214 and receives, from the encryption unit 214, the encrypted deletion ID list 132 which is generated by encrypting the deletion ID list 135.

The processing data generation unit 215 writes the encrypted deletion ID list into the control information on the deletion requisition data.

The processing data generation unit 15 accepts an input of the password “PW_A′” via the external input I/F 24, and writes the accepted password “PW_A′” into the control information.

In addition, the processing data generation unit 215 receives the signature data “Sig_A′” from the signature generation unit 216, and writes the received signature data “Sig_A” into the control information to generate the deletion requisition data 130. The processing data generation unit 215 outputs the deletion requisition data 130 to the record carrier 10 via the record carrier I/F 21.

(f) The signature generation unit 216 holds a signature key therein in advance. The signature key corresponds to the verification key held by the record carrier 10. The signature generation unit 216 generates signature data by using the signature key to the registration command, the encrypted registration ID list and the password, all of which are generated by the processing data generation unit 215. The signature generation unit 216 outputs the generated signature data to the processing data generation unit 215.

Note that the signature generation algorithm used in the signature generation unit 216 corresponds to the signature verification algorithm used in the signature verification unit 108 of the record carrier 10, and is a digital signature standard using a public-key encryption scheme.

(g) The access requisition generation unit 217 holds in advance control information on an access requisition therein. The control information is used for generating the access requisition. In the control information, only the access command 161 “/access” of the access requisition 160 is written and the encrypted device ID 162 and the required-data identifying information 163 are blanks.

The following describes a process of generating the access requisition 160 as a specific example. The access requisition generation unit 217 receives, from the encryption unit 214, the encrypted device ID 162 “E₅=(Kr, ID_A)” which is generated by encrypting the device ID of its own terminal device, “ID_A,” and writes the received encrypted device ID 162 into the control information on the access requisition. The access requisition generation unit 217 receives the required-data identifying information 163 “address directory” via the external input I/F 24, and writes the received required-data identifying information 163 into the control information to generate the access requisition 160. The access requisition generation unit 217 outputs the generated access requisition 160 to the record carrier 1Q via the record carrier I/F 21.

(h) The data output unit 218 receives data from the record carrier 10 via the record carrier I/F 21, and outputs the received data to the display unit 25.

2.4 External Input I/F 24

The external input I/F 24 is, specifically speaking, a plurality of keys provided on the operating panel of the cellular phone 20. When the user pushes keys, the external input I/F 24 generates signals corresponding to the pushed keys and outputs the generated signals to the controller 23.

2.5. Display Unit 25

The display unit 25 is specifically speaking a display unit, and displays the data outputted from the data output unit 218 on a display.

3. PDA 30

The PDA 30 is assumed to be a terminal device owned by the same user of the cellular phone 20. The PDA 30 has a card slot in which the record carrier 10 can be placed. In addition, the PDA 30 holds in advance the device ID of its own terminal device, “ID_B,” therein. Note that a diagram showing the structure of the PDA 30 is not presented since it has the same structure as the cellular phone 20.

The PDA 30 differs from the cellular phone 20 in that the PDA 30 does not register device information with the record carrier 10, and only makes an access requisition. In the process of the access requisition, the PDA 30 reads out the device ID of its own terminal device, “ID_B,” and generates an encrypted device ID by encrypting the readout device ID. The PDA 30 outputs to the record carrier 10 the access requisition which includes the encrypted device ID.

The access requisition 170 shown in FIG. 8B is an example of the access requisition generated by the PDA 30. As shown in the figure, the access requisition 170 comprises an access command 171 “/access,” an encrypted device ID 172 “E₅(Kr, ID_B)” and required-data identifying information 173 “protected mail data.”

4. PC 40

The PC 40 is assumed to be a terminal device owned by the same user of the cellular phone 20. The PC 40 has a card slot in which the record carrier 10 can be placed. In addition, the PC 40 holds in advance the device ID of its own terminal device, “ID_C,” therein. Note that a diagram showing the structure of the PC 40 is not presented since it has the same structure as the cellular phone 20.

As is the case of the PDA 30, the PC 40 does not register device information with the record carrier 10, and only makes an access requisition. In the process of the access requisition, the PC 40 reads out the device ID of its own terminal device, “ID_C,” and generates an encrypted device ID by encrypting the readout device ID. The PC 40 outputs to the record carrier 10 the access requisition which includes the encrypted device ID.

The access requisition 180 shown in FIG. 8C is an example of the access requisition generated by the PC 40. As shown in the figure, the access requisition 180 comprises an access command 181 “/access,” an encrypted device ID 182 “E₅ (Kr, ID_C)” and required-data identifying information 183 “APP2.”

5. Cellular Phone 50

The cellular phone 50 is assumed to be a terminal device owned by a different individual from the user of the cellular phone 20, the PDA 30 and the PC 40. The cellular phone 50 has a card slot in which the record carrier 10 can be placed. In addition, the cellular phone 50 holds in advance the device ID of its own terminal device, “ID_E,” therein. Note that a diagram showing the structure of the cellular phone 50 is not presented since it has the same structure as the cellular phone 20.

The following assumes that the user of the cellular phone 50 attempts to access data stored in the record carrier 10 owned by a different individual by placing the record carrier 10 in the card slot of the cellular phone 50.

The cellular phone 50 reads out the device ID of its own terminal device, “ID_E,” and generates an encrypted device ID by encrypting the readout device ID. The cellular phone 50 outputs an access requisition including the generated encrypted device ID to the record carrier 10.

The access requisition 190 shown in FIG. 8D is an example of the access requisition generated by the cellular phone 50. As shown in the figure, the access requisition 190 comprises an access command 191 “/access,” an encrypted device ID 192 “E₅(Kr, ID_E)” and a required-data identifying information 193 “image data.”

The record carrier 10 has not registered the cellular phone 50, which is a device of the other individual, with the access authorized device table 140. Therefore, even if the cellular phone 50 outputs the access requisition 190 to the record carrier 10, the cellular phone 50 cannot access the data of the record carrier 10 since the record carrier 10 judges that the cellular phone 50 does not have a right to access the data.

<Operations>

1. Overall Operations

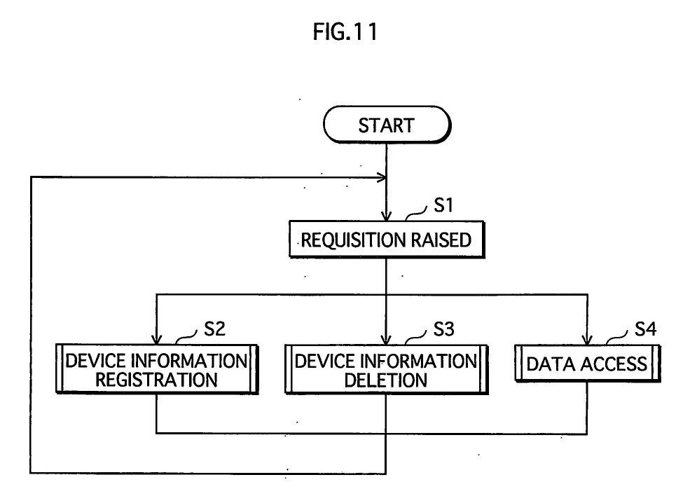

FIG. 11 is a flowchart illustrating overall operations of the data protection system 1.

A requisition is raised (Step S1), and a process according to the requisition is conducted. In the case where the requisition at Step S1 is “registration,” the registration process of device information is conducted (Step S2). When the requisition is “deletion,” the deletion process of device information is conducted (Step S3). When the requisition is “access,” the data access process is conducted (Step S4). When a required process is completed, the operations return to Step S1.

2. Registration Process of Device Information

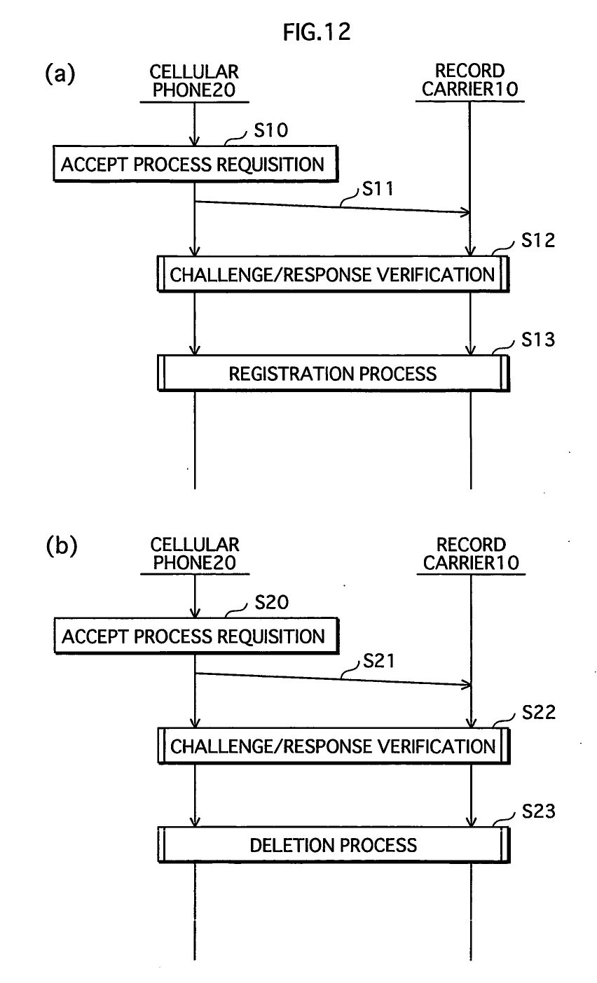

FIG. 12A is a flowchart illustrating operations for the registration process of device information performed between the record carrier 10 and the cellular phone 20. Note that the operations described here are details of Step S2 in FIG. 11.

The cellular phone 20 accepts a process requisition indicating a registration of device information (Step S10), and outputs a process-launch requisition to the record carrier 10 (Step S11). When the record carrier 10 receives the process-launch requisition, a challenge/response verification is implemented between the record carrier 10 and the cellular phone 20 (Step S12). Subsequently, the registration process is conducted (Step S13).

3. Deletion Process of Device Information

FIG. 12B is a flowchart illustrating operations for the deletion process of device information performed between the record carrier 10 and the cellular phone 20. Note that the operations described here are details of Step S3 in FIG. 11.

The cellular phone 20 accepts a process requisition indicating a deletion of device information (Step S20), and outputs a process-launch requisition to the record carrier (Step S21). When the record carrier 10: receives the process-launch requisition, a challenge/response verification is implemented between the record carrier 10 and the cellular phone 20 (Step S22). Subsequently, the deletion process is conducted (Step S23).”

4. Challenge/Response Verification

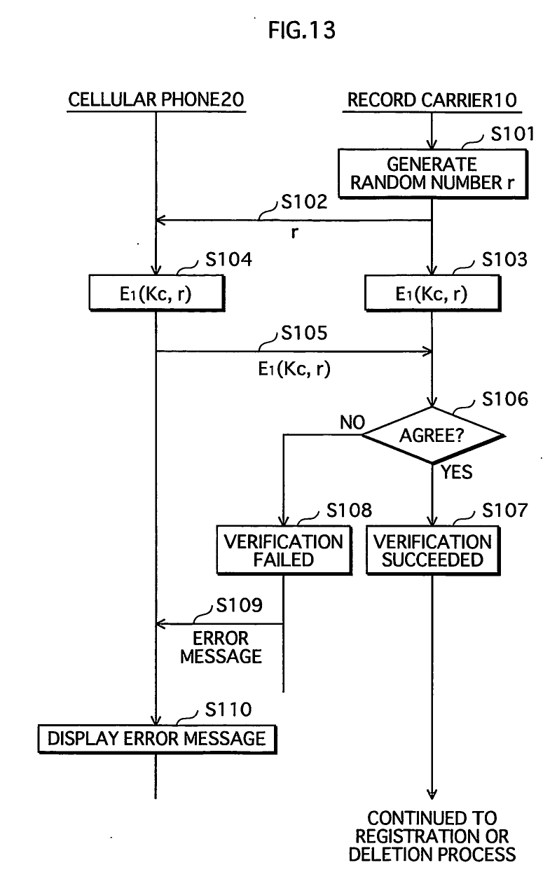

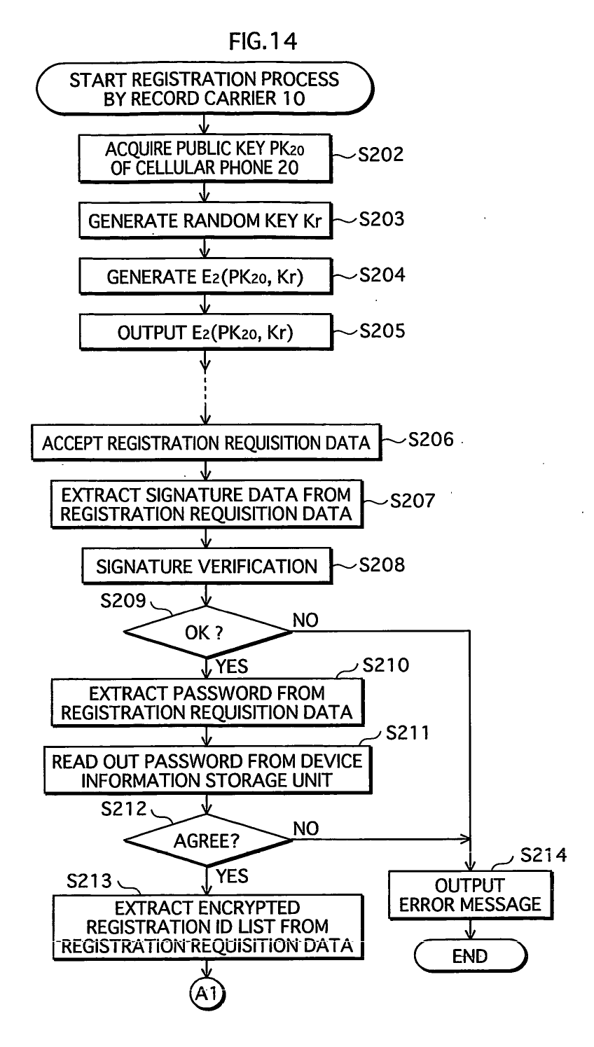

FIG. 13 is a flowchart illustrating operations of the challenge/response verification implemented between the record carrier 10 and the cellular phone 20. Note that the operations described here are details of Step 512 in FIG. 12A and Step S22 in FIG. 12B.

First, by receiving an instruction to generate a random number from the process-launch requisition receiving unit 101, the random number generation unit 102 of the record carrier 10 generates a random number r (Step S101). The random number generation unit 102 outputs the generated random number r to the cellular phone 20 via the terminal I/F 11, and the record carrier I/F 21 of the cellular phone 20 receives the random number r (Step S102).

In addition, the random number generation unit 102 outputs the random number r generated at Step S101 to the response data verification unit 103. The response data verification unit 103 generates the encrypted data C₁ by applying the encryption algorithm E₁ to the random number r, using the common key Kc held by the response data verification unit 103 therein as an encryption key (Step 5103).

Meanwhile, the controller 23 of the cellular phone 20 receives the random number r from the record carrier I/F 21, and generates response data C₁′ by applying the encryption algorithm E₁ to the random number r, using the common key Kc held by the response data verification unit 103 therein as an encryption key (Step S104). The controller 23 outputs the generated response data C₁′ to the record carrier 10 via the record carrier I/F 21, the terminal I/F 11 of the record carrier 10 receives the response data C₁′ (Step S105).

The response data verification unit 103 compares the encrypted data C₁ generated at Step S103 and the encrypted data C₁′ generated at Step S104 by the cellular phone 20. When C₁ and C₁′ match (Step S106: YES), the response data verification unit 103 judges that the verification of the cellular phone 20 is successful (Step S107), and subsequently the registration process or the deletion process is conducted between the record carrier 10 and the cellular phone 20.

When C₁ and C₁′ do not match (Step S106: NO), the response data verification unit 103 judges that the verification of the cellular phone 20 is unsuccessful (Step S108), and outputs an error message informing the cellular phone 20 accordingly via the terminal I/F 11. The record carrier I/F 21 of the cellular phone 20 receives the error message (Step S109). The controller 23 of the cellular phone 20 receives the error message from the record carrier I/F 21, and displays it on the display unit 25 (Step S110).

5. Registration

5.1 Registration Process by Record Carrier 10

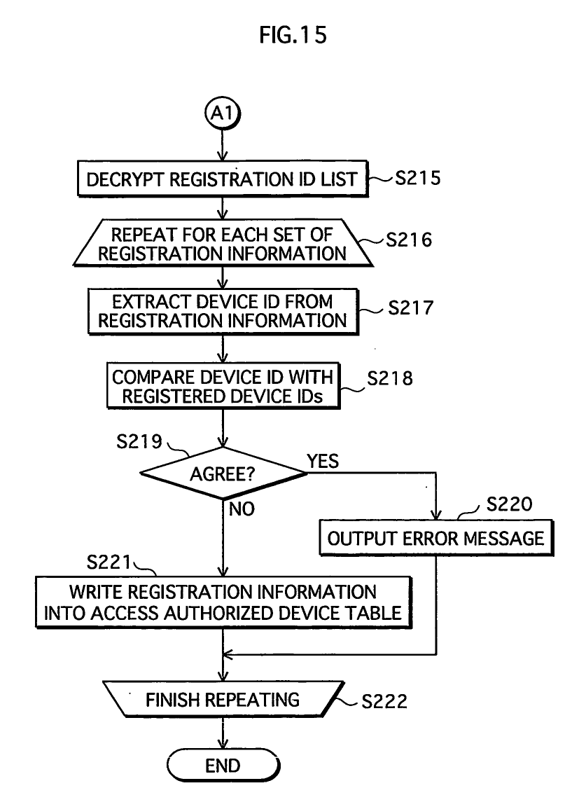

FIGS. 14 and 15 are flowcharts illustrating operations of the registration process performed by the record carrier 10. Note that the operations described here are details of Step S13 in FIG. 12A.

The public key acquisition unit 104 of the device information registration unit 14 acquires the public key PK₂₀ of the cellular phone 20 (Step S202). By receiving an instruction from the response data verification unit 103, the random key generation unit 105 generates the random key Kr (Step S203).

The encryption unit 106 acquires the public key PK₂₀ of the cellular phone 20 and the random key Kr, and generates the encrypted random key E₂(PK₂₀, Kr) by applying the encryption algorithm E₂ to the random key Kr using the public key PK₂₀ as an encryption key (Step S204). The encryption unit 106 outputs the generated encrypted random key E₂(PK₂₀, Kr) to the cellular phone 20 via the terminal I/F 11 (Step S205).

Subsequently, the processing-data accepting unit 107 accepts registration requisition data from the cellular phone 20 (Step S206). The processing-data accepting unit 107 outputs the accepted registration requisition data to the signature verification unit 108.

The signature verification unit 108 receives the registration requisition data and extracts signature data from the received registration requisition data (Step S207). The signature verification unit 108 examines the signature data by using the verification key and the signature verification algorithm on the extracted signature data (Step S208). When the verification of the signature data is unsuccessful (Step S209: NO), the signature verification unit 108 outputs an error message informing the cellular phone 20 accordingly via the terminal I/F 11 (Step S214). When the verification of the signature data is successful (Step S209: YES), the signature verification unit 108 outputs the registration requisition data to the password verification unit 109.

The password verification unit 109 receives the registration requisition data and extracts a password from the received registration requisition data (Step S210). Then, the password verification unit 109 reads out a correct password stored in the device information storage unit 15 (Step S211), and judges whether or not the password extracted at Step S210 and the correct password read out at Step S211 match.

When these two passwords do not match (Step S212: NO), the password verification unit 109 outputs, to the cellular phone 20 via the terminal I/F 11, an error message informing that the password verification is unsuccessful (Step S214). When the passwords match (Step S212: YES), the password verification unit 109 outputs the registration requisition data to the decryption unit 110.

The decryption unit 110 receives the registration requisition data, and extracts the encrypted registration ID list from the received registration requisition data (Step S213). The decryption unit 110 decrypts the encrypted registration ID list using the random key generated by the random key generation unit 105 (Step S215), and outputs the decrypted registration ID list to the data controller 111.

The data controller 111 repeats Steps S216 to S222 with respect to each set of registration information. The data controller 111 extracts a device. ID from each set of the registration information (Step S217), and compares the device ID extracted at Step S217 with all device IDs which have been registered with the access authorized device table stored in the device information storage unit 15 (Step S218).

When a corresponding device ID is found in the access authorized device table (Step S219: YES), the data controller 111 outputs, to the cellular phone 20 via the terminal I/F 11, an error message informing that the terminal device identified by the device ID has been already registered (Step S220). When a corresponding device ID is not found in the access authorized device table (Step S219: NO), the data controller 111 writes the registration information into the access authorized device table stored in the device information storage unit 15 (Step S221).

5.2 Registration Process by Cellular Phone 20

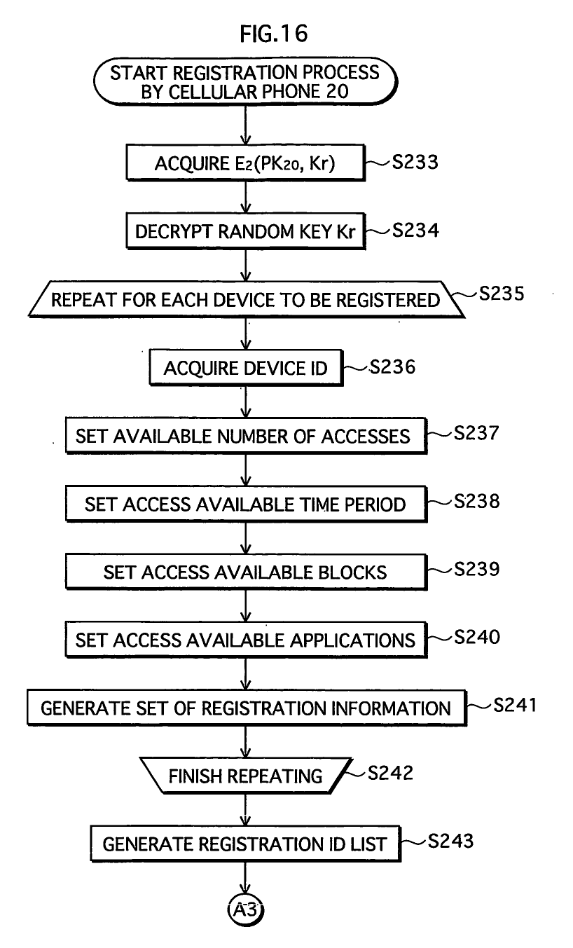

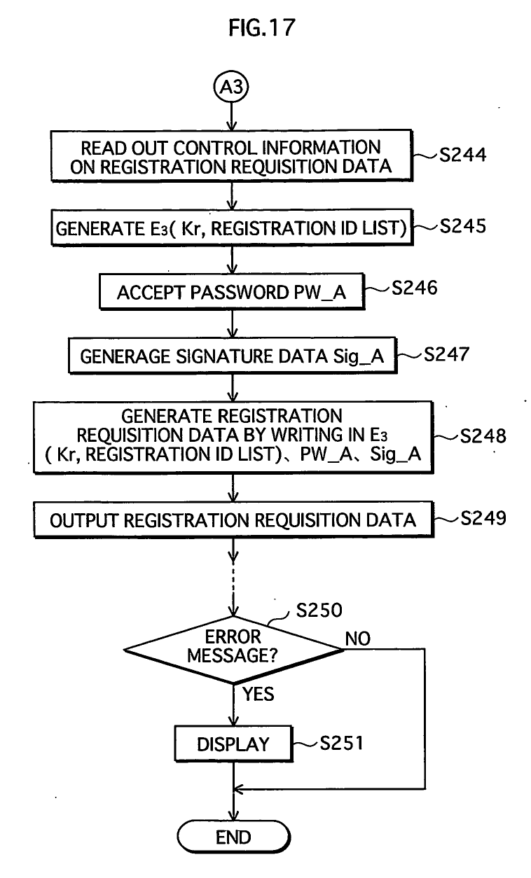

FIGS. 16 and 17 are flowcharts illustrating operations of the registration process performed by the cellular phone 20. Note that the operations described here are details of Step S13 in FIG. 12A.

The decryption unit 213 of the controller 23 acquires, from the record carrier 10 via the record carrier I/F 21, the encrypted random key E₂ (PK₂₀, Kr) which has been encrypted using the public key PK₂₀ of the cellular phone 20 (Step S233). The decryption unit 213 decrypts the received encrypted random key E₂(PK₂₀, Kr) to obtain the random key Kr (Step S234).

Subsequently, the cellular phone 20 repeats Steps S235 to 242 with respect to each device to be registered.

The processing data generation unit 215 of the controller 23 acquires a device ID of the device to be registered (Step S236). At this point, if the device to be registered is its own terminal device, i.e. the cellular phone 20, the processing data generation unit 215 acquires the device ID from the device ID storage unit 22. If the device to be registered is another device, the processing data generation unit 215 acquires the device ID from the external input I/F 24.

Next, the processing data generation unit 215 sets the available number of accesses according to an input signal received from the external input I/F 24 (Step S237). Similarly, according to respective input signals received from the external input I/F 24, the processing data generation unit 215 correspondingly sets the access available time period (Step S238), the access available blocks (Step S239), and the access available applications (Step S240). The processing data generation unit 215 generates one set of registration information comprising the device ID acquired at Step S236 and the data set at Steps 237 to 240 (Step S241).

The processing data generation unit 215 generates a registration ID list including all sets of registration information that are generated through repetitive operations of Steps S235 to S242 (Step S243).

The processing data generation unit 215 reads out the control information on the registration requisition data (Step S244), and then outputs the registration ID list generated at Step S243 to the encryption unit 214. The encryption unit 214 receives the registration ID list and generates the encrypted registration ID list E₃(Kr, registration ID list) using the random key Kr decrypted at Step S234 as an encryption key on the received registration ID list (Step S245).

Next, the processing data generation unit 215 accepts an input of the password PW_A via the external input I/F 24 (Step S246). The signature generation unit 216 generates the signature data Sig_A based on the registration command, the encrypted registration ID list and the password (Step S247). The signature generation unit 216 outputs the generated signature data Sig_A to the processing data generation unit 215.

The processing data generation unit 215 writes the encrypted registration ID list, the password, and the signature data into the control information on the registration requisition data so as to generate the registration requisition data (Step S248). The processing data generation unit 215 outputs the generated registration requisition data to the record carrier 10 via the record carrier I/P 21 (Step S249).

Afterwards, when receiving an error message (Step S250: YES), the cellular phone 20 displays the error message on the display unit 25 via the data output unit 218 (Step S251). When not receiving the error message (Step S250: NO), the cellular phone 20 terminates the process.

6. Deletion

6.1 Deletion Process by Record Carrier 10

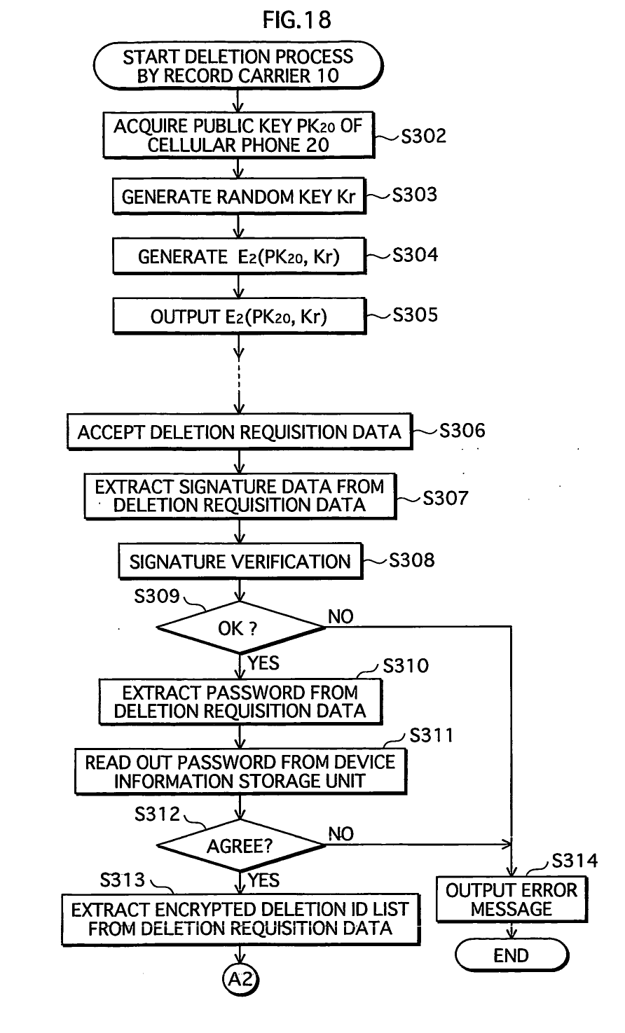

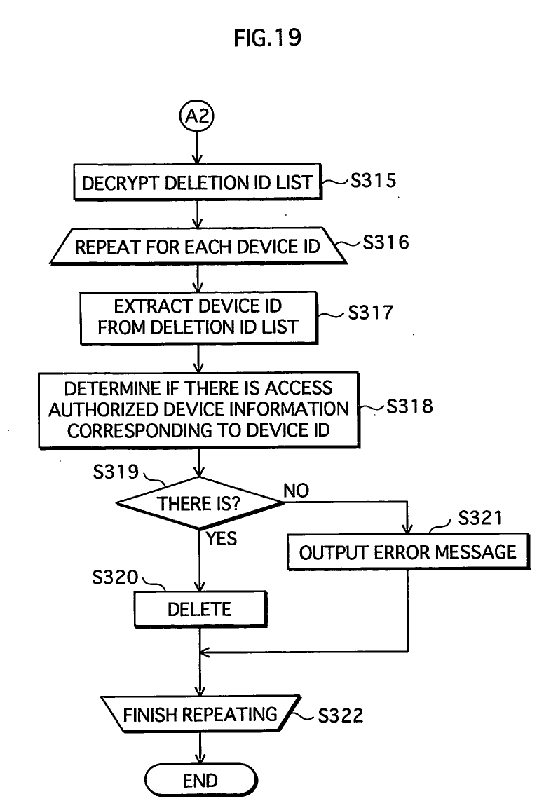

FIGS. 18 and 19 are flowcharts illustrating operations of the deletion process performed by the record carrier 10. Note that the operations described here are details of Step S23 in FIG. 12B.

The public key acquisition unit 104 of the device information registration unit 14 acquires the public key PK₂₀ of the cellular phone 20 (Step S302). By receiving an instruction from the response data verification unit 103, the random key generation unit 105 generates the random key Kr (Step S303).

The encryption unit 106 receives the public key PK₂₀ of the cellular phone 20 and the random key Kr, and generates the encrypted random key E₂ (PK₂₀, Kr) by applying the encryption algorithm E₂ to the random key Kr using the public key PK₂₀ as an encryption key (Step S304). The encryption unit 106 outputs the generated encrypted random key E₂(PK₂₀, Kr) to the cellular phone 20 via the terminal I/F 11 (Step S305).

Subsequently, the processing-data accepting unit 107 accepts deletion requisition data from the cellular phone 20 (Step S306). The processing-data accepting unit 107 outputs the accepted deletion requisition data to the signature verification unit 108.

The signature verification unit 108 receives the deletion requisition data and extracts signature data from the received deletion requisition data (Step S307). The signature verification unit 108 examines the signature data using the verification key and the signature verification algorithm on the extracted signature data (Step S308). When the verification of the signature data is unsuccessful (Step S309: NO), the signature verification unit 108 outputs an error message informing the cellular phone 20 accordingly via the terminal I/F 11 (Step S314). When the verification of the signature data is successful (Step S309: YES), the signature verification unit 108 outputs the deletion requisition data to the password verification unit 109.

The password verification unit 109 receives the deletion requisition data, and extracts a password from the received deletion requisition data (Step S310). Then, the password verification unit 109 reads out a correct password stored in the device information storage unit 15 (Step S311), and judges whether the password extracted at Step S310 and the correct password read out at Step 5311 match.

When these two passwords do not match (Step S312: NO), the password verification unit 109 outputs, to the cellular phone 20 via the terminal I/F 11, an error message informing that the password verification is unsuccessful (Step S314). When the passwords match (Step S312: YES), the password verification unit 109 outputs the deletion requisition data to the decryption unit 110.

The decryption unit 110 receives the deletion requisition data, and extracts the encrypted deletion ID list from the received deletion requisition data (Step S313). The decryption unit 110 decrypts the encrypted registration ID list using the random key generated by the random key generation unit 105 (Step 5315), and outputs the decrypted deletion ID list to the data controller 111.

The data controller 111 repeats Steps S316 to S322 with respect to each device ID. The data controller 111 extracts a device ID from each set of the registration information (Step S317), and determines if the device ID extracted at Step S317 has been registered with the access authorized device table store in the device information storage unit 15 (Step S318).

When the same device ID is not found in the access authorized device table (Step S319: NO), the data controller 111 outputs, to the cellular phone 20 via the terminal I/F 11, an error message informing that the terminal device identified by the device ID has not been registered as an access authorized device (Step S321). When the same device ID is found in the access authorized device table (Step S319: YES), the data controller 111 deletes a corresponding set of the access authorized device information which includes the device ID from the access authorized device table stored in the device information storage unit 15 (Step S320).

5.2 Deletion Process by Cellular Phone 20

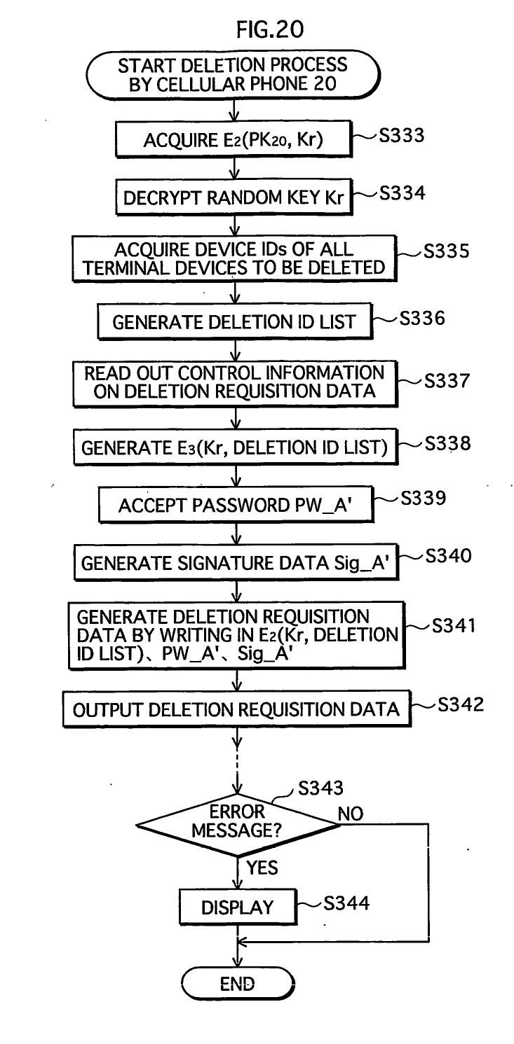

FIG. 20 is a flowchart illustrating operations of the deletion process performed by the cellular phone 20. Note that the operations described here are details of Step S23 in FIG. 12B.

The decryption unit 213 of the controller 23 acquires, from the record carrier 10 via the record carrier I/F 21, the encrypted random key E₂ (PK₂₀, Kr) which has been encrypted using the public key PK₂₀ of the cellular phone 20 (Step S333). The decryption unit 213 decrypts the received encrypted random key E₂(PK₂₀, Kr) to obtain the random key Kr (Step S334).

The processing data generation unit 215 of the controller 23 acquires device IDs of all terminal devices to be deleted (Step S335). At this point, if the device to be deleted is its own terminal device, i.e. the cellular phone 20, the processing data generation unit 215 acquires the device ID from the device ID storage unit 22. If the device to be deleted is another device, the processing data generation unit 215 acquires the device ID from the external input I/F 24. The processing data generation unit 215 generates a deletion ID list made up of all of the acquired device IDs (Step S336).

The processing data generation unit 215 reads out the control information on the deletion requisition data (Step S337), and then outputs the deletion ID list generated at Step S336 to the encryption unit 214. The encryption unit 214 receives the deletion ID list, and generates the encrypted deletion ID list E₃(Kr, deletion ID list) using the random key Kr decrypted at Step S334 as an encryption key on the received deletion ID list (Step S338).

Next, the processing data generation unit 215 accepts an input of the password PW_A via the external input I/F 24 (Step S339). The signature generation unit 216 generates the signature data Sig_A′ based on the deletion command, the encrypted deletion ID list and the password (Step S340). The signature generation unit 216 outputs the generated signature data Sig_A′ to the processing data generation unit 215.

The processing data generation unit 215 writes the encrypted deletion ID list, the password, and the signature data into the control information on the deletion requisition data, and generates the deletion requisition data (Step S341). The processing data generation unit 215 outputs the generated deletion requisition data to the record carrier 10 via the record carrier I/F 21 (Step S342).

Afterwards, when receiving an error message (Step S343: YES), the cellular phone 20 displays the error message on the display unit 25 via the data output unit 218 (Step S344). When not receiving the error message (Step S343: NO), the cellular phone 20 terminates the process.

7. Access Process

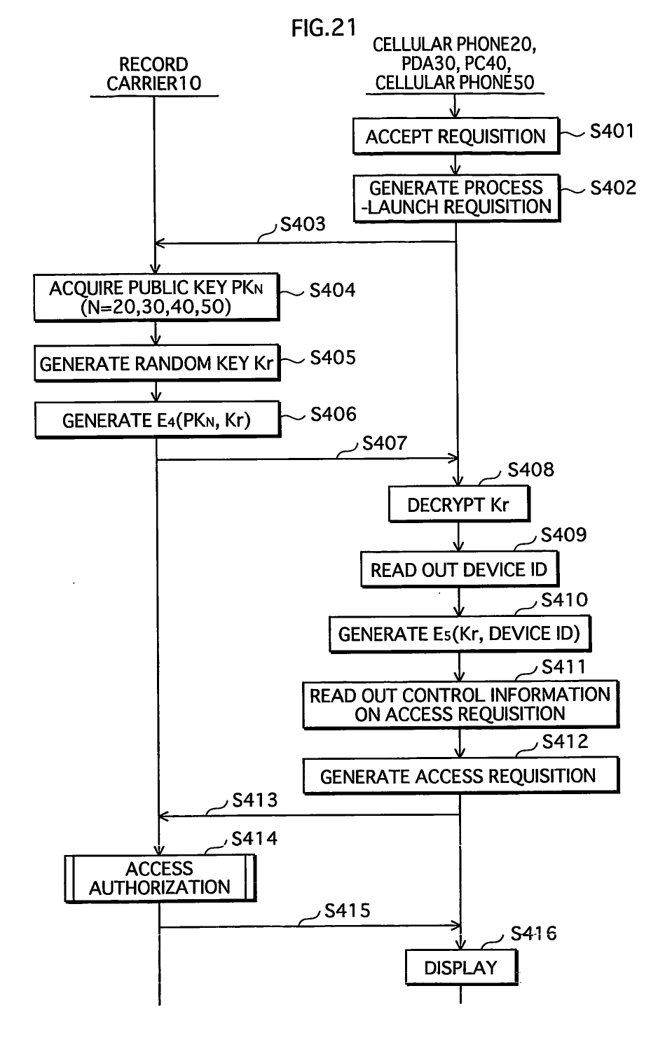

FIG. 21 is a flowchart illustrating operations of the data access process performed by the data protection system 1. Note that the operations described here are details of Step S4 in FIG. 11.

A terminal device having a card slot in which the record carrier 10 is placed accepts a requisition from the user to display given data (Step S401), and generates a process-launch requisition (Step S402). The terminal device outputs the process-launch requisition to the record carrier 10, and the record carrier 10 receives the process-launch requisition (Step S403).

The record carrier 10 acquires the public key PK_{N} of the terminal device (Step S404), where N=20, 30, 40 or 50. Next, the record carrier 10 generates the random key Kr (Step S405). The record carrier 10 generates the encrypted random key E₄ (PK_{N}, Kr) by applying the encryption algorithm E₄ to the random key Kr generated at Step S405, using the public key PK_{N} acquired at Step S404 as an encryption key (Step S406). The record carrier 10 outputs the encrypted random key to the terminal device, and the terminal device receives the encrypted random key (Step S407).

The terminal device decrypts the encrypted random key in order to obtain the random key Kr (Step S408). Next, the terminal device reads out the device ID of its own terminal device stored therein (Step S409), and generates an encrypted device ID E₅ (Kr, device ID) by applying the encryption algorithm E₅ to the device ID using the random key Kr as an encryption key (Step S410).

Next, the terminal device reads out control information on an access requisition held therein in advance (Step S411), and writes the encrypted device ID and the access required-data identifying information into the control information on the access requisition to generate the access requisition (Step S412). The terminal device outputs the access requisition to the record carrier 10, and the record carrier 10 receives the access requisition (Step S413).

The record carrier 10 performs access authorization (Step S414), and outputs the data to the terminal device based on the result of the access authorization. The terminal device receives the data outputted from the record carrier 10 (Step S415), and displays the data (Step S416). Note that an error message, instead of the data required by the terminal device, is outputted at Step S415 depending on the result of the access authorization.

8. Access Authorization

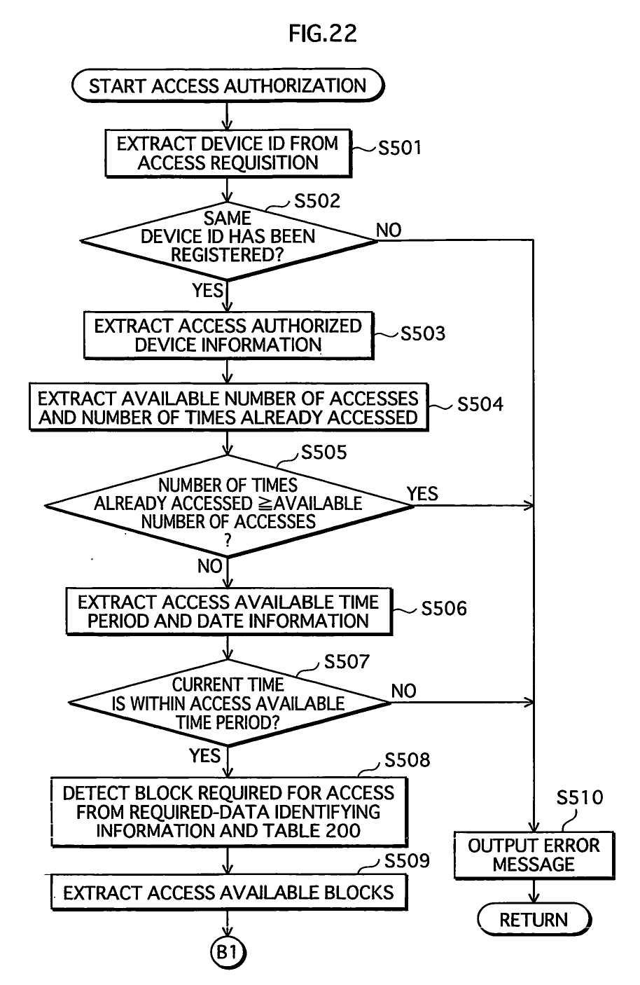

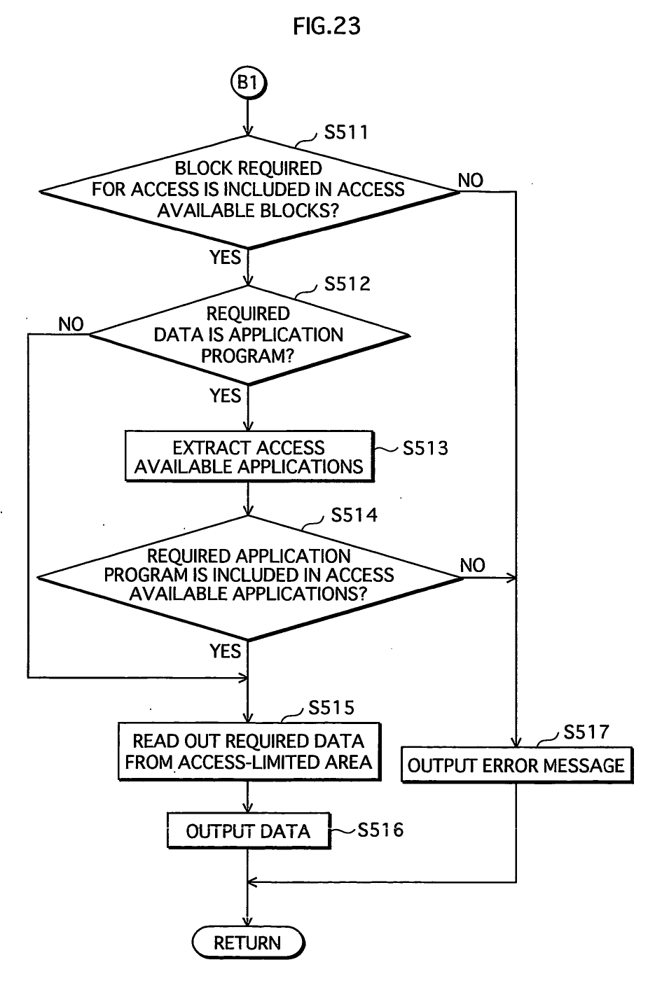

FIGS. 22 and 23 are flowcharts illustrating operations of the access authorization performed by the record carrier 10. Note that the operations described here are details of Step S414 in FIG. 21.

The decryption unit 155 of the controller 16 extracts an encrypted device ID from the access requisition (Step S500), and decrypts the encrypted device ID using the random key received from the random key generation unit 152 as a decryption key in order to obtain the device ID (Step S501). The decryption unit 155 outputs the decrypted device ID and the access required-data identifying information to the judging unit 156.

The judging unit 156 reads out the access authorized device table from the device information storage unit 15 and judges whether or not a device ID same as the one received from the decryption unit 155 has been registered with the access authorized device table. When the same device ID has not been registered (Step S502: NO), the judging unit 156 outputs, to the terminal device via the terminal I/F 11, an error message informing that the access is denied (Step S510).

When the same device ID has been registered (Step S502: YES), the judging unit 156 extracts a set of the access authorized device information which includes the device ID from the access authorized device table (Step S503). The judging unit 156 extracts the available number of accesses from the extracted access authorized device information and furthermore reads-out the number of times already accessed of the terminal device identified by the device ID (Step S504).

The judging unit 156 compares the number of times already accessed with the available number of accesses. When the number of times already accessed is the same or more than the available number of accesses (Step S505: YES), the judging unit 156 outputs, to the terminal device via the terminal I/F 11, an error message informing that the access is denied (Step S510).

When the number of times already accessed is below the available number of accesses (Step S505: NO), the judging unit 156 extracts the access available time period from the access authorized device information and furthermore acquires the date information from the date management unit 157 (Step S506). The judging unit 156 judges whether or not the current time indicated by the date information is within the access available time period. The current time is outside the access available time period (Step S507: NO), the judging unit 156 outputs, to the terminal devices via the terminal I/F 11, an error message informing that the access is denied (Step S510).

When the current time is within the access available time period (Step S507: YES), the judging unit 156 refers to the table 200 held therein, and detects a memory block in which data identified by the received required-data identifying information is stored (Step S508). Furthermore, the judging unit 156 extracts the access available blocks from the access authorized device information (Step S509), and judges whether or not the memory block in which the data being required for access is stored is included in the access available blocks.

When the memory block is not included in the access available blocks (Step S511: NO), the judging unit 156 outputs, to the terminal device via the terminal I/F 11, an error message informing that the access is denied (Step S517). When the memory block is included in the access available blocks (Step S511: YES), the judging unit 156 judges from the required-data identifying information whether or not the data being required for access is an application program. If, the data being required for access is not an application program (Step S512: NO), the process proceeds to Step S515.

If the data being required for access is an application program (Step S512: YES), the judging unit 156 extracts the access available applications from the access authorized device information (Step S513). The judging unit 156 judges whether or not the application program being required for access is included in the access available applications.

When the application program being required for access is not included in the access available applications (Step S514: NO), the judging unit 156 outputs, to the terminal device vial the terminal I/F 11, an error message informing that the access is denied (Step S517).

When the application program being required for access is included in the access available applications (Step S514: YES), the judging unit 156 directs the memory access unit 158 to read out the data, and the memory access unit 158 reads out the required data from the access-limited area 13 in the data storage unit 12 (Step S515).

The data input/output unit 159 receives the data read out from the memory access unit 158, and outputs the data to the terminal device via the terminal I/F 11 (Step S516).

### [2] Modification of the First Embodiment

Here, a data protection system 1a is described as a modification of the data protection system 1, which is the first embodiment of the present invention.

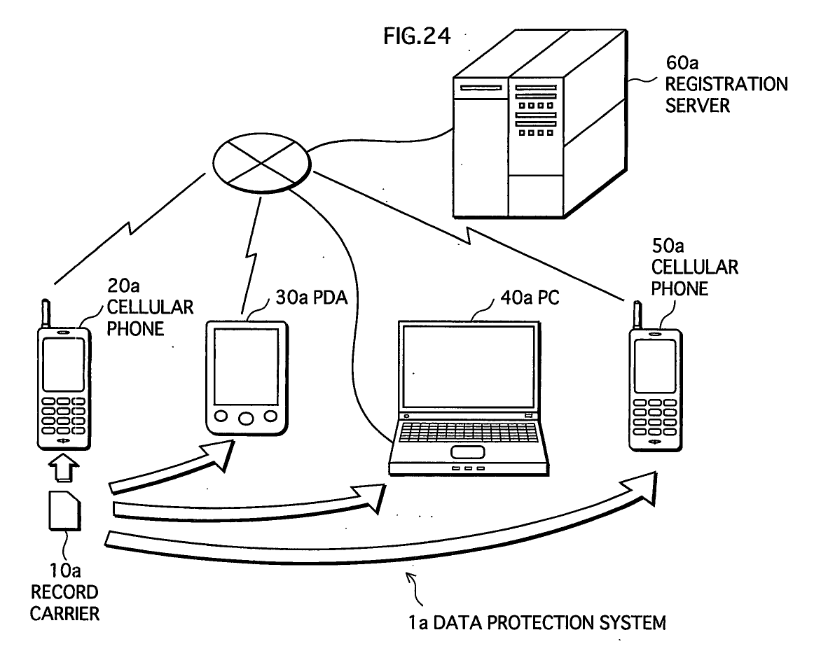

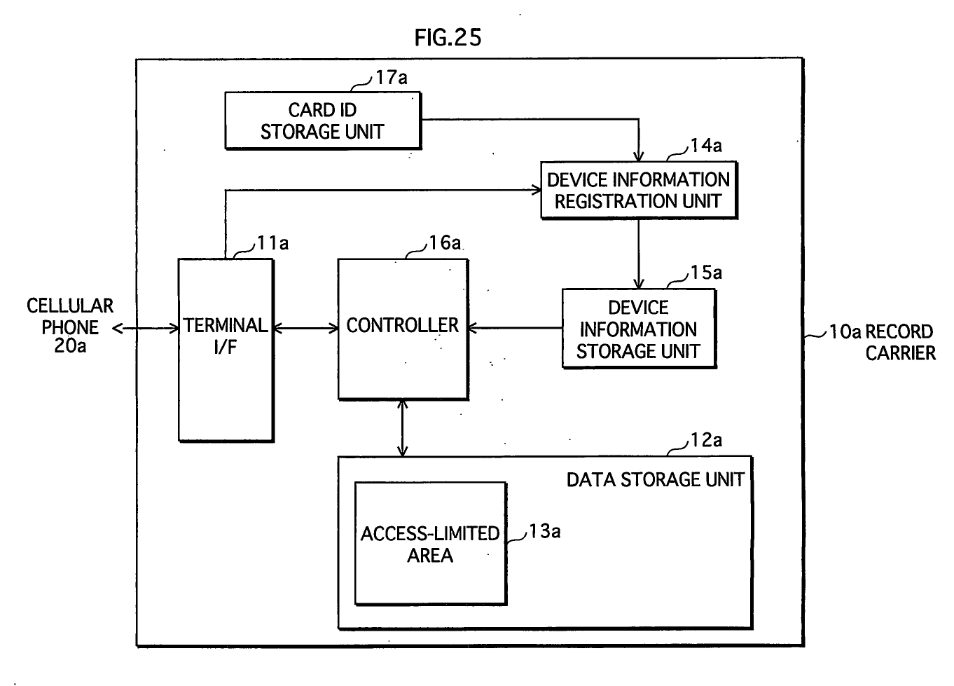

FIG. 24 shows a structure of the data protection system 1a. As shown in the figure, the data protection system 1a comprises a record carrier 10a, a cellular phone 20a, a PDA 30a, a PC 40a, a cellular phone 50a and a registration server 60a.

In the data protection system 1, the cellular phone 20 is a device dedicated for requiring a registration and a deletion of device information to the record carrier 10. Here, having the registration server 60a which requires the registration and deletion of device information of the record carrier 10a is a feature of the data protection system 1a.

1. Record Carrier 10a

FIG. 25 is a functional diagram showing a structure of the record carrier 10a.

As shown in the figure, the record carrier 10a comprises a terminal I/F 11a, a data storage unit 12a, an access-limited area 13a, a device information registration unit 14a, a device information storage unit 15a, a controller 16a and a card ID storage unit 17a. The structural difference from the record carrier 10 shown in FIG. 2 is that the record carrier 10a has a card ID storage unit 17a.

The terminal I/F 11a, the data storage unit 12a, the access-limited area 13a, the device information storage unit 15a and the controller 16a each have the same functions as the corresponding counterparts of the record carrier 10 of the first embodiment, i.e. the terminal I/F 11, the data storage unit 12, the access-limited area 13, the device information storage unit 15 and the controller 16, respectively. Therefore, the descriptions of these components are omitted.

The following description mainly focuses on differences of the record carrier 10a from the record carrier 10.

The card ID storage unit 17a stores a card ID “CID-A” for uniquely identifying the record carrier 10a.

After implementing a challenge/response verification with the registration server 60a, discussed hereinafter, the device information registration unit 14a receives registration requisition data/deletion requisition data via the terminal device. Here, the same operations shown in FIG. 13 are performed as the challenge/response verification, with “the record carrier 10” and “the cellular phone 20” substituted with “the record carrier 10a” and “the registration server 60a,” respectively.

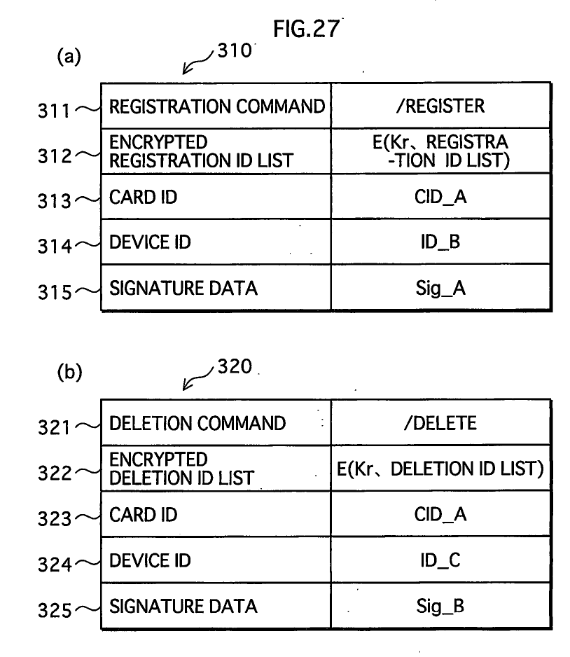

The registration requisition data comprises a registration command, an encrypted registration ID list, a card ID, a device ID and signature data. The card ID is information for identifying the record carrier that is the registration destination of the device information. The device ID is information for identifying a terminal device having the record carrier attached thereto, where the record carrier is a deletion destination of the device information. The signature data is a digital signature generated based on the registration command, the encrypted device ID list, the card ID and the device ID. The registration requisition data 310 shown in FIG. 27A is an example of the registration requisition data.

The deletion requisition data comprises a deletion command, an encrypted deletion ID list, a card ID, a device ID and signature data. The card ID is information for identifying the record carrier that is a deletion destination of the device information. The device ID is information for identifying a terminal device having the record carrier attached thereto, where the record carrier is a deletion destination of the device information. The signature data is a digital signature generated based on the deletion command, the encrypted deletion ID list, the card ID and the device ID. The deletion requisition data 320 shown in FIG. 27B is an example of the deletion requisition data.

The device information registration unit 14a judges whether or not the card ID included in the registration requisition data/the deletion requisition data and the card ID stored in the card ID storage unit 17a match. The device information registration unit 14a also judges whether or not the device ID included in the registration requisition data/the deletion requisition data and the device ID of the terminal device having the record carrier 10a attached thereto match.

Furthermore, the device information registration unit 14a holds in advance a verification key for verifying the signature data generated by the registration server 60a, verifies the signature data included in the registration requisition data/the deletion requisition data using the verification key, and judges whether or not the registration requisition data/the deletion requisition data has been tampered.

When the card IDs match, and the device IDs match, and furthermore the verification of the signature data is successful, the device information registration unit 14a conducts the registration process or the deletion process of the access authorized device information.

2. Cellular Phone 20a

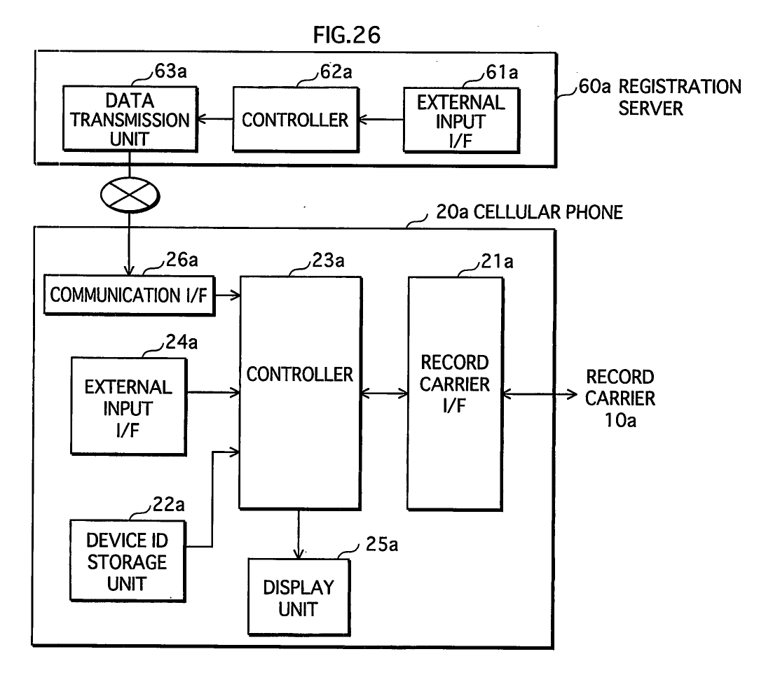

As shown in FIG. 26, the cellular phone 20a comprises a record carrier I/F 21a, a device ID storage unit 22a, a controller 23a, an external input I/F 24a, a display unit 25a and a communication I/F 26a.

The record carrier I/F 21a is, specifically speaking, a card slot, and the record carrier 10a is placed in the card slot.

The communication I/F 26a is a network connection unit, and is connected with the registration server 60a via a network.

In response to a requisition from the record carrier 10a, in the registration and deletion processes of device information, the cellular phone 20a outputs, to the record carrier 10a, its own terminal device's device ID, which is stored in the device ID storage unit 22a.

Although the cellular phone 20 of the first embodiment generates the registration requisition data and the deletion requisition data, the cellular phone 20a does not generate such requisition data. Instead, the cellular phone 20a receives the registration requisition data and the deletion requisition data generated by the registration server 60a via a network, and outputs the received registration requisition data and the deletion requisition data to the record carrier 10a.

Since the data access process of the cellular phone 20a is the same as that of the cellular phone 20, the description is omitted.

3. PDA 30a and PC 40a

It is assumed that the PDA 30a and the PC 40a are terminal devices owned by the user of the cellular phone 20a.

The PDA 30a and the PC 40a have the same structure as the cellular phone 20a. The PDA 30a and PC 40a both have card slots in which a record carrier 10a can be placed. In addition, both PDA 30a and PC 40a have network connection units, and are connected with the registration server 60a via a network.

In response to a requisition from the record carrier 10a, in the registration and deletion processes of device information, each of the PDA 30a and the PC 40a outputs its own terminal device's device ID stored therein to the record carrier 10a.

The record carrier 10 of the first embodiment is capable of conducting the registration and deletion processes of device information only when it is attached to the cellular phone 20. According to the present modification, however, the PDA 30a and PC 40a receive the registration requisition data and the deletion requisition data generated by the registration server 60a via a network and output the received registration requisition data and the deletion requisition data to the record carrier 10a in the same manner as the cellular phone 20a. Hence, according to the present modification, the record carrier 10a is capable of conducting the registration and deletion processes of the device information even when it is attached to the PDA 30a or the PC 40a.

Since the data access processes of the PDA 30a and the PC 40a are the same as those of the PDA 30 and the PC 40, the descriptions are omitted.

4. Cellular Phone 50a

It is assumed that the cellular phone 50a is a terminal device owned by a different person other than the user of the cellular phone 20a, the PDA 30a and the PC 40a.

The cellular phone 50a has the same structure as the cellular phone 20a. The cellular phone 50a has a card slot in which the record carrier 10a can be placed. Furthermore, the cellular phone 50a has a network connection unit and can be connected to the registration server 60a via a network.

The cellular phone 50a, which is a terminal device of another individual, is not registered with the access authorized device table of the record carrier 10a. Therefore, even if the cellular phone 50a outputs an access requisition to the record carrier 10a, the cellular phone 50a cannot access the data of the record carrier 10a since the record carrier 10a judges that the cellular phone 50a does not have a right to access the data.

5. Registration Server 60a

The registration server 60a is a server apparatus that requires a registration and a deletion of device information to a record carrier, and has functions corresponding to the device information registration and deletion of the cellular phone 20 according to the first embodiment.

As shown in FIG. 26, the registration server 60a comprises an external input I/F 61a, a controller 62a and a data transmission unit 63a.

The external input I/F 61a accepts registration request data or deletion request data of device information from outside.

The registration request data comprises: a registration instruction indicating a request regarding the registration process; a card ID for identifying the record carrier that is the registration destination; a device ID for identifying the terminal device having the record carrier attached thereto, where the record carrier is the registration destination; an available number of accesses; an access available time period; access available blocks; access available applications; a user name and a user password of the user requesting the registration process; and transmission destination information.

The deletion request data comprises: a deletion instruction indicating a request regarding the deletion process; a card ID for identifying the record carrier that is the deletion destination; as device ID for identifying the terminal device having the record carrier attached thereto, where the record carrier is the registration destination; a user name and a user password of the user requesting the deletion process; and transmission destination information.

The external input I/F 61a outputs the accepted registration request data or the deletion request data to the controller 62a.

The controller 62a has the same functions as the controller 23 of the cellular phone 20 according to the first embodiment. The controller 62a differs from the controller 23 in receiving a registration of the user name and user password from the owner of the record carrier 10a in advance and storing these.

The controller 62a receives the registration request data or the deletion request data from the external input I/F 61a, and verifies the user by judging whether or not the user name and the password included in the received registration request data/the deletion request data match the registered user name and the password, respectively. Only when the user authentication is successful, the controller 62a generates the registration requisition data based on the registration request data or generates the deletion requisition data based on the deletion request data.

FIG. 27A shows an example of the registration requisition data generated by the controller 62a. As shown in the figure, the registration requisition data 310 comprises: the registration command 311 “/register”; the encrypted registration ID list 312 “E(Kr, registration ID list)”; the card ID 313 “CID_A”; the device ID 314 “ID_B”; and the signature data 315 “Sig_A.” The card ID 313 “CID_A” and the device ID 314 “ID_B” are respectively a card ID and a device TD included in the registration request data received from the external input I/F 61. The way of generating the encrypted registration ID list is the same as in the case of the controller 23, and Kr used as an encryption key is the random key generated in the record carrier 10a. The controller 62a outputs, to the data transmission unit 63a, the generated registration requisition data along with the transmission destination information.

FIG. 27B shows an example of the deletion requisition data generated by the controller 62a. As shown in the figure, the deletion requisition data 320 comprises: the deletion command 321 “/delete”; the encrypted deletion ID list 322 “E(Kr, deletion ID list)”; the card ID 323 “CID_A”; the device ID 324 “ID_C”; and the signature data 325 “Sig_B.” The card ID 323 “CID_A” and the device ID 324 “ID_C” are respectively a card ID and a device ID included in the deletion request data received from the external input I/F 61. The way of generating the encrypted deletion ID list is the same as in the case of the controller 23, and Kr used as an encryption key is the random key generated in the record carrier 10a. The controller 62a outputs, to the data transmission unit 63a, the generated deletion requisition data along with the transmission destination information.

The data transmission unit 63a is a network connection unit. The data transmission unit 63a receives the registration requisition data and the transmission destination information from the controller 62a, and transmits, via a network, the received registration requisition data to the terminal device indicated by the transmission destination information. The data transmission unit 63a receives the deletion requisition data and the transmission destination information from the controller 62a, and transmits, via a network, the received deletion requisition data to the terminal device indicated by the transmission destination information.

As described above, the present modification is defined by that the registration server 60a, instead of the cellular phone 20a, generates the registration requisition data and the deletion requisition data, and transmits the generated registration requisition data and the deletion requisition data to the record carrier 10a via the terminal device having the record carrier 10a attached thereto. This allows to realize the registration and deletion processes of device information not only when the record carrier 10a is attached to the cellular phone 20a, but also when it is attached to the PDA 30a and to the PC 40a.

Furthermore, the registration server 60a is capable of preventing the user of the cellular phone 50a from registering unauthorized device information by implementing the user authentication in which the user name and user password are required.

### [3] Second Embodiment

The following gives a description of a data protection system 2 according to a second embodiment of the present invention.

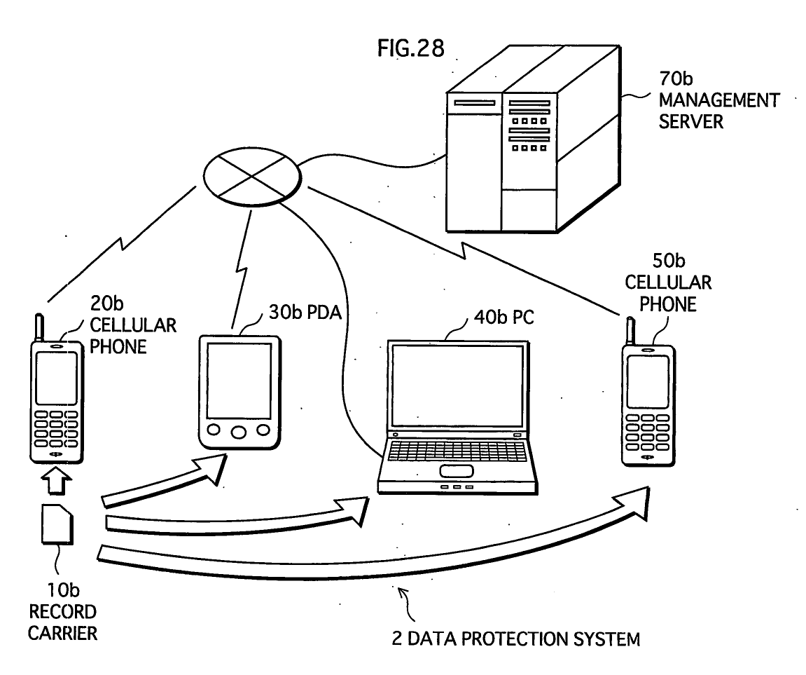

FIG. 28 shows a structure of the data protection system 2. As shown in the figure, the data protection system 2 comprises a record carrier 10b, a cellular phone 20b, a PDA 30b, a PC 40b, a cellular phone 50b and a management server 70b.

In the data system 1, the record carrier 10 holds therein the access authorized device table indicating devices authorized to access the record carrier 10. The data protection system 2 is defined by that the management server 70b holds the access authorized device table which indicates devices authorized to access the record carrier 10b.

Note that a registration and a deletion of device information to the management server 70b are conducted using the cellular phone 20b.

<Structure>

1. Record Carrier 10b

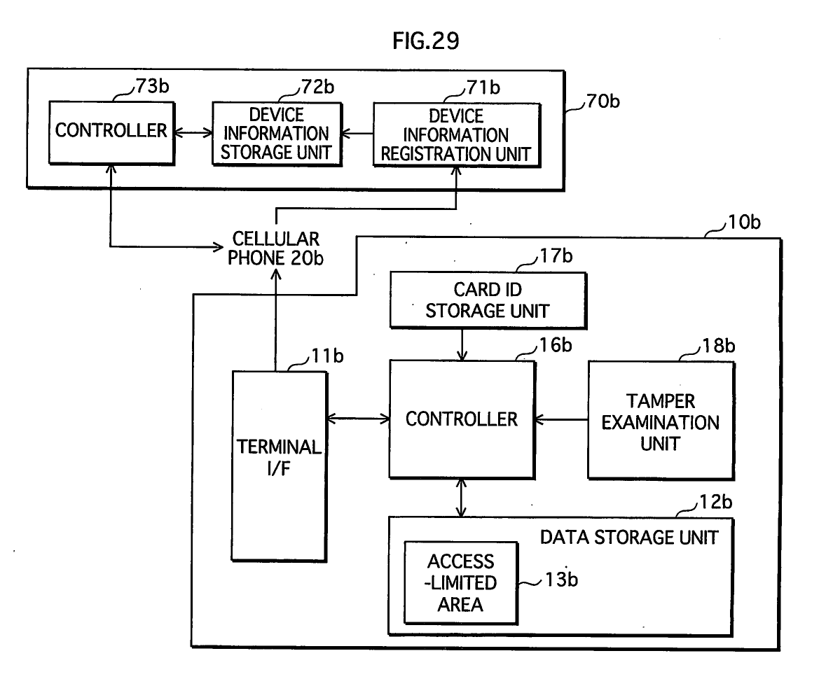

As shown in FIG. 29, the record carrier 10b comprises a terminal I/F 11b, a data storage unit 12b, an access-limited area 13b, a controller 16b, a card ID storage unit 17b and a tamper examination unit 18b.

The record carrier 10b does not have components corresponding to the device information registration unit 14 and the device information stooge unit 15 of the record carrier 10, while the card ID storage unit 17b and the tamper examination unit 18b are added to the record carrier 10.

Since the device I/F 11b, the data storage unit 12b and the access-limited area 13b are the same as the terminal I/F 11, the data storage unit 12 and the access-limited area 13 of the record carrier 10, respectively, descriptions for these are omitted. The following description mainly focuses on differences of the record carrier 10b from the record carrier 10.

The card ID storage unit 17b stores a card ID “CID_A” for uniquely identifying the record carrier 10b.

The tamper examination unit 18b holds in advance a verification key for verifying signature data generated by the management server 70b, and examines the signature data outputted from the controller 16b using the verification key in order to judge whether or not the data received by the controller 16b has been tampered. The tamper examination unit 18b outputs the examination result of the signature data to the controller 16b.

When accepting an access requisition from a terminal device, the controller 16b reads out the card ID from the card ID storage unit 17b, and transmits the readout card ID to the management server 70b via the terminal I/F 11b, the terminal device and a network.

The controller 16b acquires the access authorized device table and the signature data from the management server 70b, and outputs the acquired signature data to the tamper examination unit 18b. When the verification of the signature data conducted by the tamper examination unit 18b is successful, the controller 16b performs access authorization using the acquired access authorized device table. The operations of the access authorization are the same as in the case of the record carrier 10 of the first embodiment.

2. Cellular Phone 20b

The cellular phone 20b has the same structure as the cellular phone 20a of the data protection system 1a. The cellular phone 20b has a network connection unit, and is capable of connecting to the management server 70b via a network.

As in the case of the cellular phone 20 of the first embodiment, the cellular phone 20b is a device dedicated for registration and deletion processes of device information. The cellular phone 20 performs the registration and deletion processes of device information with the record carrier 10, however, the cellular phone 20b performs the registration and deletion processes of device information, not with the record carrier 10b, but with the management server 70b that manages the access authorized device table.

The cellular phone 20b generates registration requisition data including the card ID “CID_A” of the record carrier 10b, and transmits the generated registration requisition data to the management server 70b. Similarly, the cellular phone 20b generates deletion requisition data including the card ID “CID_A” of the record carrier 10b, and transmits the generated deletion requisition data to the management server 70b.

In addition, the cellular phone 20b has a card slot, and makes an access requisition to the record carrier 10b when the record carrier 10b is placed in the card slot.

3. PDA 30b, PC 40b and Cellular Phone 50b

The PDA 30b, the PC 40b, the cellular phone 50b have the same structures as the PDA 30a, the PC 40a and the cellular phone 50a, respectively. Namely, each of these terminal devices has a network connection unit, and is capable of connecting with the management server 70 via a network. Furthermore, each of these terminal devices has a card slot and makes an access requisition to the record carrier 10b when the record carrier 10b is placed in the card slot.

Note that these terminal devices do not conduct the registration and deletion processes of device information to the management server 70b. This is the same as in the case of the first embodiment.

4. Management Server 70b

The management server 70b has a device information registration unit 71b, a device information storage unit 72b and a controller 73b as shown in FIG. 29.

The device information registration unit 71b has the same function and structure as the device information registration unit 14 (FIG. 4) of the record carrier 10 according to the first embodiment. Namely, when receiving the registration requisition data from the cellular phone 20b, the device information registration unit 71b registers access authorized device information with the device information storage unit 72b based on the received registration requisition data. When receiving the deletion requisition data from the cellular phone 20b, the device information registration unit 71b deletes access authorized device information from the device information storage unit 72b based on the received deletion requisition data.

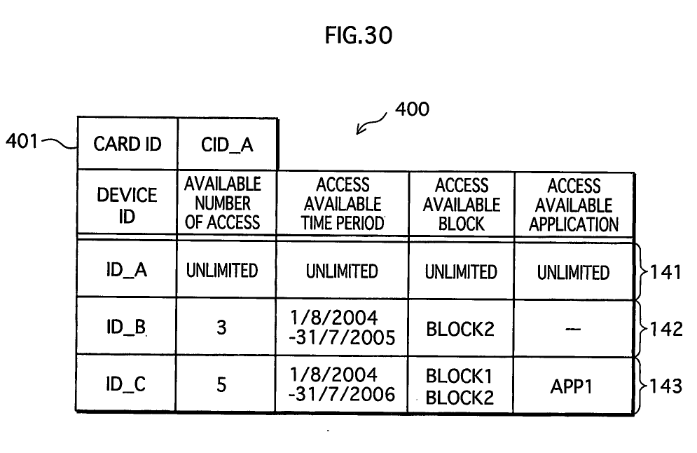

The device information storage unit 72b stores the access authorized device table. FIG. 30 shows an example of the access authorized device table. As shown in the figure, the access authorized device table 400 has a data structure which is configured by adding a card ID 401 “CID_A” to the access authorized device table 140 (FIG. 6) of the first embodiment.

In the first embodiment, since the record carrier 10 itself holds the access authorized device table 140, it is apparent that the access authorized device table 140 indicates terminal devices authorized to access the access-limited area 13 of the record carrier 10.

In the second embodiment, since the management server 70b holds the access authorized device table 400, the card ID 401 indicates that the table is information on terminal devices authorized to access the access-limited area of the record carrier 10b which is identified by the card ID “CID_A.”

When receiving the card ID “CID_A” from the record carrier 10b via the terminal device and the network, the controller 73b extracts the access authorized device table 400 including “CID_A” from the device information storage unit 72b.

Furthermore, the controller 73b holds in advance a signature key for generating signature data. The controller 73b generates the signature data by using the signature key on the extracted access authorized device table 400, and transmits the generated signature data along with the access authorized device table 400 to the record carrier 10b via the terminal device and the network.

<Operations>

The following describes operations of the data protection system 2.

1. Overall Operations

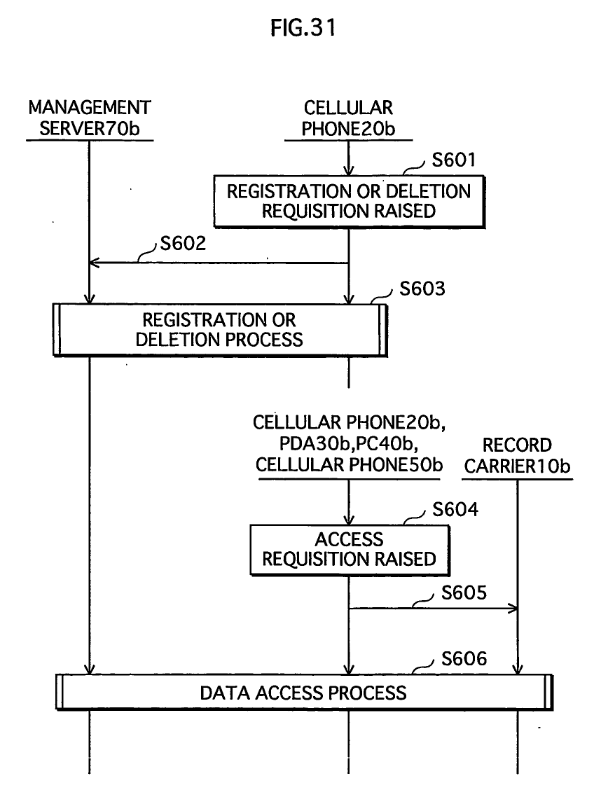

FIG. 31 is a flowchart illustrating overall operations of the data protection system 2. First, a registration requisition/a deletion requisition of device information is raised as a result of accepting an input from the user (Step S601). The cellular phone 20b transmits the registration requisition/the deletion requisition to the management server 70b via the network, and the management server 70b receives the registration requisition/the deletion requisition (Step S602) Next, the management server 70b and the cellular phone 20b conduct the registration process/the deletion process (Step S603).

Subsequently, the cellular phone 20b, the PDA 30b, the PC 40b or the cellular phone 50b, any of which the record carrier 10b is placed in its card slot accepts the input from the user, and thereby an access requisition is raised (Step S604). The terminal device outputs the access requisition to the record carrier 10b, and the record carrier 10b receives the access requisition (Step S605). Then, the record carrier 10b and the management server 70b conduct the data access process (Step S606).

2. Registration and Deletion Processes

Operations of the registration process by the cellular phone 20b are the same as those by the cellular phone 20 of the first embodiment (FIGS. 16 and 17). Additionally, operations of the deletion, process by the cellular phone 20b are the same as those by the cellular phone 20 of the first embodiment (FIG. 20).

Furthermore, operations of the registration process by the management server 70b are the same as those by the record carrier 10 of the first embodiment (FIGS. 14 and 15), and operations of the deletion process by the management server 70b are the same as those by the record carrier 10 of the first embodiment (FIGS. 18 and 19).

3. Data Access Process

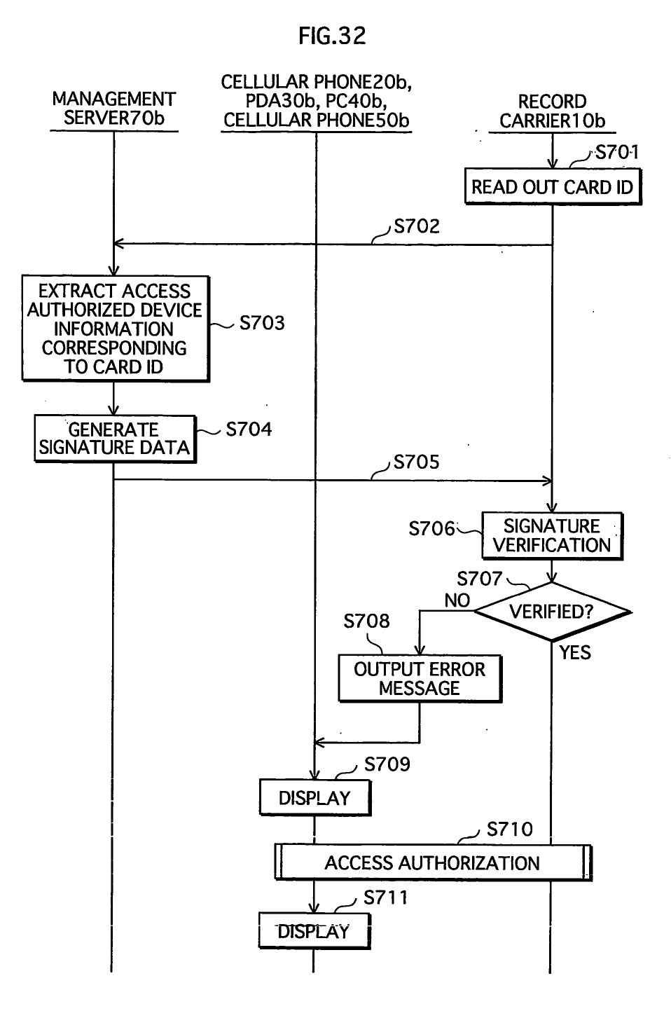

FIG. 32 is a flowchart illustrating operations of the data access process. The operations described here are details of Step S606 in FIG. 31.

The controller 16b of the record carrier 10b reads out a card ID from the card ID storage unit 17b (Step S701). The controller 16b transmits the readout card ID to the management server 70b via the terminal I/F 11b, the terminal device and the network. The controller 73b of the management server 70b receives the card ID (Step S702).

The controller 73b extracts an access authorized device table including the received card ID from the device information storage unit 72b (Step S703). Next, the controller 73b generates signature data corresponding to the extracted access authorized device table (Step S704). The controller 73b transmits the access authorized device table and the signature data to the record carrier 10b via the terminal device and the network, and the record carrier 10b receives the access authorized device table and the signature data (Step S705).

The tamper examination unit 18b of the record carrier 10b receives the signature data received at Step S705, and examines the signature data using a verification key held in the tamper examination unit 18b (Step S706). When the verification of the signature data is unsuccessful (Step S707: NO), the tamper examination unit 18b generates an error message informing that the data access is denied, and outputs the generated error message to the terminal device (Step S708).

When receiving the error message, the terminal device displays the received error message on the display unit (Step S709).

When the verification of the signature data is successful (Step S707: YES), the tamper examination unit 18b informs the controller 16b accordingly. Then, the controller 16b conducts access authorization (Step S710).

The terminal device displays, on the display unit, information received from the record carrier 10b (Step S711). The information displayed reflects the result of the access authorization at Step 710.

4. Access Authorization

Operations of the access authorization performed by the record carrier 10b are the same as those performed by the record carrier 10 of the first embodiment (FIGS. 22 and 23).

### [4] Other Modifications

(1) In the first embodiment, instead of the cellular phone 20, other dedicated devices can be used for the registration of device information. For example, a case can be considered in which device IDs of devices authorized to access the record carrier would be registered at the time of sale, using a special device at a cellular phone shop and such. In this case, the password entry at the time of registration is not required.

(2) In the first and second embodiments, biometric information of the authorized user may be included in the access authorized device information in advance. Then, the authorization for accessing the access-limited area is implemented, the record carrier may acquire the operator's biometric information via the terminal device and judge whether or not the acquired biometric information matches the biometric information registered with the access authorized device information.

Fingerprints, irises, and voiceprints can be thought of as the biometric information here.

(3) In the first and second embodiments, a password specified in advance by the authorized user may be included in the access authorized device information. Then, the authorization for accessing the access-limited area is implemented, the record carrier may acquire, via, the terminal device, the password entered by the user and judge whether or not the acquired password matches the password registered with the access authorized device information.

Note here that the timing for implementing the password verification can be varied. The password verification can be implemented, for example, for each access requisition, at regular time intervals, or immediately after power on.

(4) In the second embodiment, the record carrier is connected to the management server through a network every time an access requisition is raised, and accesses the access authorized device table. However, this structure is not necessarily required and the following structure may be adopted instead.

For example, the record carrier may access the management server at predetermined time intervals regardless of the access requisition, or may access the management server every time when the record carrier is placed in a card slot of a different terminal device.

(5) In the modification of the first embodiment, the record carrier 10a and the management server 60a may implement the challenge-response verification prior to the registration and deletion processes of device information.

(6) In the first embodiment, the record carrier conducts a registration and a deletion of access authorized device information. Here, the record carrier may be configured so as not only to register and delete, but also to update the access authorized device information.

Similarly, in the second embodiment, the management server may be configured so as not only to register and delete the access authorized device information, but also to update this information.

(7) The present invention may be methods of accomplishing the above described data protection systems. The invention may be a computer program to realize these methods using a computer, or may be digital signals representing the computer program.

The present invention may also be a computer-readable storage medium, such as a flexible disk, a hard disk, a CD-ROM (Compact Disc Read Only Memory), MO (Magneto-Optical) disc, a DVD (Digital Versatile Disc), a DVD-ROM (Digital Versatile Disc Read Only Memory), a DVD-RAM (Digital Versatile Disc Random Access Memory), a BD (Blu-ray Disc), or a semiconductor memory, on which the above-mentioned computer program or digital signals are recorded. The present invention may also be the computer program or the digital signals recorded on such a storage medium.

The present invention may also be the computer program or digital signals to be transmitted via networks, as represented by telecommunications, wire/wireless communications, and the Internet.

The present invention may also be a computer system having a microprocessor and a memory, wherein the memory stores the computer program, and the microprocessor operates according to the computer program.

The computer program or digital signals may be stored into the above storage medium and transferred to an independent computer system, or alternatively, may be transferred to an independent computer system via the above network. Then, the independent computer system may execute the computer program or digital signals.

(8) The present invention includes a structure in which two or more of the above embodiments and modifications are combined.

### INDUSTRIAL APPLICABILITY

The present invention can be utilized, for example in an electronic money system where IC cards are used, as a mechanism for preventing unauthorized use of the IC cards when the IC cards are lost or stolen.

1. A record carrier comprising:
a storage unit;
a requisition receiving unit operable to receive, from a terminal device having the record carrier attached thereto, a requisition for access to the storage unit;
an acquisition unit operable to acquire an access condition indicating whether or not the terminal device is authorized to access the storage unit;
a judging unit operable to judge whether or not the requisition satisfies the access condition; and
a prevention unit operable to prevent the access of the terminal device to the storage unit when the judging unit judges that the requisition does not satisfy the access condition.

2. The record carrier of claim 1, further comprising:
an access condition storage unit operable to store the access condition, wherein
the acquisition unit acquires the access condition from the access condition storage unit.

3. The record carrier of claim 2, wherein
the access condition include an identifier list including one or more identifiers which respectively identify one or more devices authorized to access the storage unit,
the requisition includes a requiring device identifier for identifying the terminal device, and
the judging unit judges that, (i) when an identifier matching the requiring device identifier is included in the identifier list, the requisition satisfies the access condition, and (ii) when an identifier matching the requiring device identifier is not included in the identifier list, the requisition does not satisfy the access condition.

4. The record carrier of claim 2, wherein
the access condition includes an identifier list including one or more identifiers and one or more sets of number information which correspond one-to-one with the identifiers respectively, the one or more identifiers identifying one or more devices authorized to access the storage unit, each set of number information indicating a count of accesses available for the corresponding device to access the storage unit,
the requisition includes a requiring device identifier for identifying the terminal device,
the judging unit includes:
a holding unit operable to hold a count of accesses indicating how many times the terminal device has accessed the storage unit;
a 1st judging subunit operable to judge whether or not an identifier matching the requiring device identifier is included in the identifier list; and
a 2nd judging subunit operable to judge, when the 1st judging subunit judges that the matching identifier is included, whether or not a count indicated by a set of number information corresponding to the matching identifier is larger than the count of accesses held by the holding unit, and
the judging unit judges that, (i) when either one of a judgment result by the 1st judging subunit and a judgment result by the 2nd judging subunit, is negative, the requisition does not satisfy the access condition, and (ii) when both the judgment results are positive, the requisition satisfies the access condition.

5. The record carrier of claim 2, wherein
the access condition includes an identifier list including one or more identifiers and one or more sets of period information which correspond one-to-one with the identifiers respectively, the one or more identifiers identifying one or more devices authorized to access the storage unit, each set of period information indicating a time period available for the corresponding device to access the storage unit,
the requisition includes a requiring device identifier for identifying the terminal device, and
the judging unit includes:
a time managing unit operable to manage a current date and time;
a 1st judging subunit operable to judge whether or not an identifier matching the requiring device identifier is included in the identifier list; and
a 2nd judging subunit operable to judge, when the 1st judging subunit judges that the matching identifier is included, whether or not the current time is within a time period indicated by a set of period information corresponding to the matching identifier, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

6. The record carrier of claim 2, wherein
the storage unit includes a plurality of memory blocks,
the access condition includes an identifier list including one or more identifiers and one or more sets of memory block information, which correspond one-to-one with the identifiers respectively identifying one or more devices authorized to access the storage unit, the sets of memory block information each indicating one or more of the memory blocks available for each of the corresponding devices to access,
the requisition includes a requiring device identifier for identifying the terminal device and memory block specifying information for specifying one of the memory blocks, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not the memory block specified by the memory block specifying information is included in the one or more of the memory blocks indicated by a set of the memory block information corresponding to the matching identifier, and
the judging unit judges, that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

7. The record carrier of claim 2, wherein
the storage unit stores one or more sets of program data,
the access condition includes an identifier list including one or more identifiers and one or more sets of program information, which correspond one-to-one with the identifiers respectively identifying one or more devices authorized to access the storage unit, the sets of program information each indicating one or more sets of the program data available for each of the corresponding devices to access,
the requisition includes a requiring device identifier for identifying the terminal device and program specifying, information for specifying one set of the program data, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not the set of program data specified by the program specifying information is included in the one or more sets of the program data indicated by a set of the program information corresponding to the matching identifier, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

8. The record carrier of claim 2, wherein
the access condition includes (i) an identifier list including one or more identifiers which respectively identify one or more devices authorized to access the storage unit, and (ii) a biometrics list including one or more sets of biometric information for respectively identifying one or more users authorized to access the storage unit,
the requisition includes a requiring device identifier for identifying the terminal device and operator biometric information indicating biometric information of an operator of the terminal device, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not a set of the biometric information corresponding to the operator biometric information is included in the biometrics list, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

9. The record carrier of claim 2, wherein
the access condition includes (i) an identifier list including one or more identifiers which respectively identify one or more devices authorized to access the storage unit, and (ii) a password list including one or more sets of password information respectively specified by one or more users authorized to access the storage unit,
the requisition includes a requiring device identifier for identifying the terminal device and an entry password entered by an operator of the terminal device, and
the judging unit includes:
a 1st judging subunit operable to judge whether or not an identifier matching the requiring device identifier is included in the identifier list; and
a 2nd judging subunit operable to judge whether or not a password indicated by a set of password information corresponding to the entry password is included in the password list, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

10. The record carrier of claim 2, further comprising:
an access condition accepting unit operable to accept the access condition from a terminal device having the record carrier attached thereto; and
an access condition registration unit operable to register, when the terminal device is authorized, the access condition with the access condition storage unit.

11. The record carrier of claim 10, wherein
the access condition registration unit includes:
a 1st key information holding unit holds 1st key information shared with the authorized terminal device; and
an output unit operable to output challenge data to the terminal device having the record carrier attached thereto; and
an examination unit operable to receive response data from the terminal device having the record carrier attached thereto and examine the received response data,
and the access condition registration unit authenticates that, when, as a result of the examination, the response data is verified as data generated by using the challenge data and the 1st key information, the terminal device having the record carrier attached thereto is the authorized terminal device.

12. The record carrier of claim 11, wherein
the access condition accepting unit accepts the access condition which has been encrypted using an access condition encryption key, and
the access condition registration unit decrypts the encrypted access condition based on the access condition encryption key, and registers the decrypted access condition with the access condition storage unit.

13. The record carrier of claim 12, wherein
the access condition accepting unit further accepts signature data generated based on the access condition, and
the access condition registration unit examines the signature data using a verification key relevant to the authorized terminal device, and registers, when the signature data is successfully verified, the decrypted access condition with the access condition storage unit.

14. The record carrier of claim 13, wherein
the access condition includes an identifier list including one or more identifiers which respectively identify one or more devices authorized to access the storage unit.

15. The record carrier of claim 13, wherein
the access condition includes an identifier list,
the identifier list, comprises one or more identifiers and one or more sets of number information which correspond one-to-one with the identifiers,
the one or more identifiers respectively identify one or more devices authorized to access the storage unit, and
each set of number information indicates a count of accesses available for the corresponding devices to access the storage unit.

16. The record carrier of claim 13, wherein
the access condition includes an identifier list,
the identifier list comprises one or more identifiers and one or more sets of period information which correspond one-to-one with the identifiers,
the one or more identifiers respectively identify one or more devices authorized to access the storage unit, and
each set of period information respectively indicates a time period available for the corresponding device to access the storage unit.

17. The record carrier of claim 13, wherein
the storage unit comprises a plurality of memory blocks,
the access condition includes an identifier list,
the identifier list comprises one or more identifiers and one or more sets of memory block information, which correspond one-to-one with the identifiers,
the identifiers respectively identify one or more devices authorized to access the storage unit, and
the sets of memory block information each indicate one or more of the memory blocks available for each of the corresponding devices to access.

18. The record carrier of claim 13, wherein
the storage unit stores one or more sets of program data,
the access condition includes an identifier list,
the identifier list comprises one or more identifiers and one or more sets of program information, which correspond one-to-one with the identifiers,
the identifiers respectively identify one or more devices authorized to access the storage unit, and
the sets of program information each indicate one or more sets of the program data available for each of the corresponding devices to access.

19. The record carrier of claim 13, wherein
the access condition includes an identifier list and a biometrics list,
the identifier list comprises one or more identifiers respectively identifying one or, more devices authorized to access the storage unit, and
the biometrics list comprises one or more sets of biometric information for respectively identifying one or more users authorized to access the storage unit.

20. The record carrier of claim 13, wherein
the access condition includes an identifier list and a password list,
the identifier list comprises one or more identifiers respectively identifying one or more devices authorized to access the storage unit, and
the password list comprises one or more sets of password information respectively specified by one or more users authorized to access the storage unit.

21. The record carrier of claim 2, further comprising:
a deletion requisition receiving unit operable to receive, from the terminal device having the record carrier attached thereto, a requisition for deletion of the access condition stored by the access condition storage unit,
an authentication unit operable to authenticate whether or not the terminal device is authorized, and an access condition deletion unit operable to delete, when the authentication unit authenticates that the terminal device is authorized, the access condition from the access condition storage unit according to the requisition.

22. The record carrier of claim 2, further comprising:
an update requisition receiving unit operable to receive, from the terminal device having the record carrier attached thereto, a requisition for update of the access condition stored by the access condition storage unit,
an authentication unit operable to authenticate whether or not the terminal device is authorized, and
an access condition update unit operable to update, when the authentication unit authenticates that the terminal device is authorized, the access condition according to the requisition.

23. The record carrier of claim 1, further comprising:
a communication unit operable to communicate with an access condition management server connected via a network, wherein
the acquisition unit acquires the access condition from the access condition management server via the communication unit.

24. The record carrier of claim 23,
wherein the acquisition unit acquires from the access condition management server via the communication unit, along with the access condition, signature data generated based on the access condition, and
the record carrier further comprising:
a tamper detection unit operable to examine the signature data using a verification key relevant to the access condition management server, and detect whether or not the access condition has been tampered; and
a prohibition unit operable to prohibit, when the tamper detection detects that the access condition has been tampered, the judging unit from judging

25. The record carrier of claim 24, wherein
the access condition includes an identifier list including one or more identifiers which respectively identify one or more devices authorized to access the storage unit,
the requisition includes a requiring device identifier for identifying the terminal device, and
the judging unit judges that, (i) when an identifier matching the requiring device identifier is included in the identifier list, the requisition satisfies the access condition, and (ii) when an identifier matching the requiring device identifier is not included in the identifier list, the requisition does not satisfy the access condition.

26. The record carrier of claim 24, wherein
the access condition includes an identifier list including one or more identifiers and one or more sets of number information which correspond one-to-one with the identifiers respectively, the one or more identifiers identifying one or more devices authorized to access the storage unit, each set of number information indicating a count of accesses available for the corresponding device to access the storage unit,
the requisition includes a requiring device identifier for identifying the terminal device, the judging unit includes:
a holding unit operable to hold a count of accesses indicating how many times the terminal device has accessed the storage unit;
a 1st judging subunit operable to judge whether or not an identifier matching the requiring device identifier is included in the identifier list; and
a 2nd judging subunit operable to judge, when the 1st judging subunit judges that the matching identifier is included, whether or not a count indicated by a set of number information corresponding to the matching identifier is larger than the count of accesses held by the holding unit, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

27. The record carrier of claim 24, wherein
the access condition includes an identifier list including one or more identifiers and one or more sets of period information which correspond one-to-one with the identifiers respectively, the one or more identifiers identifying one or more devices authorized to access the storage unit, each set of period information indicating a time period available for the corresponding device to access the storage unit,
the requisition includes a requiring device identifier for identifying the terminal device, and
the judging unit includes:
a time managing unit operable to manage a current date and time;
a 1st judging subunit operable to judge whether or not an identifier matching the requiring device identifier is included in the identifier list; and
a 2nd judging subunit operable to judge, when the 1st judging subunit judges that the matching identifier is included, whether or not the current time is within a time period indicated by a set of period information corresponding to the matching identifier, and
the judging unit judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

28. The record carrier of claim 24, wherein
the storage unit comprises a plurality of memory blocks,
the access condition includes an identifier list including one or more identifiers and one or more sets of memory block information, which correspond one-to-one with the identifiers respectively identifying one or more devices authorized to access the storage unit, the sets of memory block information each indicating one or more of the memory blocks available for each of the corresponding devices to access,
the requisition includes a requiring device identifier for identifying the terminal device and memory block specifying information for specifying one of the memory blocks, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not the memory block specified by the memory block specifying information is included in the one or more of the memory blocks indicated by a set of the memory block information corresponding to the matching identifier,
and judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

29. The record carrier of claim 24, wherein
the storage unit stores one or more sets of program data,
the access condition includes an identifier list including one or more identifiers and one or more sets of program information, which correspond one-to-one with the identifiers respectively identifying one or more devices authorized to access the storage unit, the sets of program information each indicating one or more sets of the program data available for each of the corresponding devices to access,
the requisition includes a requiring device identifier for identifying the terminal device and program specifying information for specifying one set of the program data, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not the set of program data specified by the program specifying information is included in the one or more sets of the program data indicated by a set of the program information corresponding to the matching identifier,
and judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

30. The record carrier of claim 24, wherein
the access condition includes (i) an identifier list including one or more identifiers which respectively identify one or more devices authorized to access the storage unit, and (ii) a biometrics list including one or more sets of biometric information for respectively identifying one or more users authorized to access the storage unit,
the requisition includes a requiring device identifier for identifying the terminal device and operator biometric information indicating biometric information of an operator of the terminal device, and
the judging unit includes:
a 1st judging subunit operable to judge whether or not an identifier matching the requiring device identifier is included in the identifier list; and
a 2nd judging subunit operable to judge, when the 1st judging subunit judges that the matching identifier is included, whether or not a set of the biometric information corresponding to the operator biometric information is included in the biometrics list,
and judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

31. The record carrier of claim 24, wherein
the access condition includes (i) an identifier list including one or more identifiers which respectively identify one or more devices authorized to access the storage unit, and (ii) a password list including one or more sets of password information respectively specified by one or more users authorized to access the storage unit,
the requisition includes a requiring device identifier for identifying the terminal device and an entry password entered by an operator of the terminal device, and
the judging unit includes:
a 1st judging subunit operable to judge whether or not an identifier matching the requiring device identifier is included in the identifier list; and
a 2nd judging subunit operable to judge whether or not a password indicated by a set of password information corresponding to the entry password is included in the password list,
and judges that, (i) when either one of a judgment result by the 1st judging subunit and a judgment result by the 2nd judging subunit is negative, the requisition does not satisfy the access condition, and (ii) when both the judgment results are positive, the requisition satisfies the access condition.

32. The record carrier of claim 23, wherein
the acquisition unit acquires, each time when the requisition receiving unit receives the requisition, the access condition from the access condition management server.

33. The record carrier of claim 23, wherein
the acquisition unit requires the access condition from the access condition management server at predetermined time intervals.

34. The record carrier of claim 23, wherein
the acquisition unit acquires, when it is detected that the record carrier is attached to a terminal device, the access condition from the access condition management server.

35. A data protection system comprising:
a record carrier including:
a storage unit,
a requisition receiving unit operable to receive, from a terminal device having the record carrier attached thereto, a requisition for access to the storage unit, an access condition storage unit operable to store an access condition indicating whether or not the terminal device is authorized to access the storage unit,
a judging unit operable to judge whether or not the requisition satisfies the access condition, and
a prevention unit operable to prevent the access to the storage unit when the judging unit judges the requisition does not satisfy the access condition; and
a terminal device including:
a record carrier interface operable to attach the record carrier thereto,
an access requisition generation unit operable to generate the requisition of the record carrier to the storage unit, and
an access requisition output unit operable to output, to the record carrier, the generated requisition for access.

36. The data protection system of claim 35, further comprising:
an access condition registration server operable to register the access condition with the access condition storage unit of the record carrier via the terminal device having the record carrier attached thereto.

37. A data protection system comprising:
a record carrier including,
a storage unit,
a requisition receiving unit operable to receive, from a terminal device having the record carrier attached thereto, a requisition for access to the storage unit,
an access condition storage unit operable to store an access condition indicating whether or not the terminal device is authorized to access the storage unit,
a judging unit operable to judge whether or not the requisition satisfies the access condition, and
a prevention unit operable to prevent the access to the storage unit when the judging unit judges the requisition does not satisfy the access condition;
a terminal device including,
a record carrier interface operable to attach the record carrier thereto,
an access requisition generation unit operable to generate the requisition of the record carrier to the storage unit, and
an access requisition output unit operable to output, to the record carrier, the generated requisition for access; and
an access condition management server connected, via a network, with the terminal device having the record carrier attached thereto, including,
an access condition storage unit operable to store the access condition, and
an access condition transmission unit operable to transmit the access condition to the record carrier via the terminal device having the record carrier attached thereto.

38. A data protection method used by a record carrier including a storage unit and an access condition storage unit, comprising the steps of:
(a) receiving, from a terminal device having the record carrier attached thereto, a requisition for access to the storage unit;
(b) acquiring, from the access condition storage unit, an access condition indicating whether or not the terminal device is authorized to access the storage unit;
(c) judging whether or not the requisition satisfies the access condition; and
(d) preventing the access to the storage unit when the step (c) judges that the requisition does not satisfy the access condition.

39. A data protection program used by a record carrier including a storage unit and an access condition storage unit, comprising the steps of:
(a) receiving, from a terminal device having the record carrier attached thereto, a requisition for access to the storage unit;
(b) acquiring, from the access condition storage unit, an access condition indicating whether or not the terminal device is authorized to access the storage unit;
(c) judging whether or not the requisition satisfies the access condition; and
(d) preventing the access to the storage unit when the step (c) judges that the requisition does not satisfy the access condition.

40. A data protection method used by a record carrier including a storage unit, comprising the steps of:
(a) receiving, from a terminal device having the record carrier attached thereto, a requisition for access to the storage unit;
(b) communicating with an access condition management server connected via a network;
(c) acquiring from the access condition management server, as a result of the step (b), an access condition indicating whether or not the terminal device is authorized to access the storage unit;
(d) judging whether or not the requisition satisfies the access condition; and
(e) preventing the access to the storage unit when the step (d) judges that the requisition does not satisfy the access condition.

41. A data protection program used by a record carrier including a storage unit, comprising the steps of:
(a) receiving, from a terminal device having the record carrier attached thereto, a requisition for access to the storage unit;
(b) communicating with an access condition management server connected via a network;
(c) acquiring from the access condition management server, as a result of the step (b), an access condition indicating whether or not the terminal device, is authorized to access the storage unit;
(d) judging whether or not the requisition satisfies the access condition; and
(e) preventing the access to the storage unit when the step (d) judges that the requisition does not satisfy the access condition.
